(19) United States
(12) Patent Application Publication
(10) Pub. No.: US 2025/0303589 A1
(43) Pub. Date: Oct. 2, 2025

(54) ROBOT WITH EXTRA-HUMAN BEHAVIOR

(71) Applicant: Boston Dynamics, Inc., Waltham, MA (US)

(72) Inventors: Jakob Welner, Hilleroed (DK); Gregory Izatt, Watertown, MA (US); Robin Deits, Lexington, MA (US); Scott Kuindersma, Bedford, MA (US); Yeuhi Abe, Cambridge, MA (US); Shigeru Kanzaki, Woburn, MA (US); Leland Hepler, Lexington, MA (US); David Robert, Somerville, MA (US); Benjamin J. Stephens, Cambridge, MA (US)

(21) Appl. No.: 19/079,646

(22) Filed: Mar. 14, 2025

Related U.S. Application Data
(60) Provisional application No. 63/572,571, filed on Apr. 1, 2024.

(51) Int. Cl. B25J 17/00; B25J 9/16; B25J 11/00

(52) U.S. Cl. CPC B25J 17/00; B25J 9/1661; B25J 9/1664; B25J 11/0005

(57) ABSTRACT

Methods and apparatus for controlling a robot (e.g., having a set of continuous rotation joints) to perform extra human behaviors are provided. The method includes receiving task information to perform a task, determining, using a control system of the robot, a motion plan for the robot to perform the task, wherein the motion plan includes rotation about one or more joints of the robot (e.g., about at least one of the continuous rotation joints in the set of continuous rotation joints) to efficiently perform the task using extra human behaviors.

### CROSS-REFERENCE TO RELATED APPLICATION

This application claims the benefit of priority under 35 U.S.C. § 119(e) to U.S. Provisional Application Ser. No. 63/572,571, entitled “ROBOT WITH EXTRA-HUMAN BEHAVIOR,” filed Apr. 1, 2024, the entire contents of which is incorporated herein by reference.

### FIELD OF THE INVENTION

This disclosure relates generally to robotics and more specifically to systems, methods and apparatuses for configuring a robot to perform extra-human behaviors.

### BACKGROUND

A robot is generally defined as a reprogrammable and multifunctional manipulator designed to move material, parts, tools, and/or specialized devices (e.g., via variable programmed motions) for performing tasks. Robots may include manipulators that are physically anchored (e.g., industrial robotic arms), mobile devices that move throughout an environment (e.g., using legs, wheels, or traction-based mechanisms), or some combination of one or more manipulators and one or more mobile devices. Robots are currently used in a variety of industries, including, for example, manufacturing, warehouse logistics, transportation, hazardous environments, exploration, and healthcare.

### SUMMARY

A variety of settings today demand high levels of automation, e.g., factories, transportation facilities, material handling facilities and warehouses, among others. At least some of the automation in such environments may be provided by robots that can perform tasks, such as moving objects (e.g., automobile parts) from a first location to a second location (e.g., a so-called “pick and place” operation), lifting heavy objects, etc. While certain types of tasks in such environments may be performed by robots mounted at a fixed location or mobile wheeled robots, other tasks may be more well-suited for robots with legs. Humanoid robots may be legged robots that include components (e.g., feet, arms, torso, head, hands) modeled after the human form with members connected by joints that enable the members to rotate with one or more degrees of freedom about the joint.

In industrial settings, the speed at which a task can be performed may be an important factor when evaluating whether and/or how to use robots. Current humanoid robots tend to spend a substantial amount of time moving between locations, particularly when the robot needs to change directions. Additionally, performing movement behaviors while grasping and/or manipulating objects can be challenging for current humanoid robots, as robot grippers may be more limited than human hands in their ability to securely grasp objects with dexterity.

Many prior attempts at humanoid robots have closely mimicked the human form, in terms of appearance and/or capabilities, for a variety of reasons. Some of those reasons have included (1) a recognition that the world with which humanoids interact has been built around the human form; (2) a belief that because nature has had millions of years to evolve a highly advanced biological form for interacting with the world, this form should be mimicked by default in machines; and (3) a fascination with the human form in its own right (e.g., as a means to understand more about human capabilities). The inventors have recognized and appreciated that these reasons do not ultimately need to restrain the capabilities of humanoid robots, and that in certain respects, it may be ideal to move beyond the capabilities of human beings or prior humanoid robots.

The present invention includes systems, methods and apparatuses for extending the capabilities of conventional humanoid robots, for example by including a set of joints in a robot that have ranges of motion that enable the performance of behaviors that conventional humanoid robots are unable to achieve. In some embodiments, a set of continuous rotation joints enables independent control of different portions of the robot, resulting in highly efficient movement and/or object manipulation capabilities, which may extend beyond the capabilities of a human being. In some embodiments, certain highly efficient movements and/or object manipulation capabilities do not necessarily depend on any particular joint or set of joints being capable of continuous rotation.

In some embodiments, the invention features a robot. The robot includes a base, a set of continuous rotation joints, each continuous rotation joint permitting continuous rotation of an attached member about a corresponding axis, wherein the set of continuous rotation joints includes a first hip joint, a second hip joint, and a back joint, a first leg member coupled to the base via the first hip joint, a second leg member coupled to the base via the second hip joint, and a torso coupled to the base via the back joint.

In one aspect, the set of continuous rotation joints further includes a neck joint, and the robot further includes a head coupled to the torso via the neck joint. In another aspect, the set of continuous rotation joints further includes a third hip joint and a fourth hip joint, and the robot further includes a first intermediate member coupled to the base at the third hip joint and coupled to the first leg member at the first hip joint, and a second intermediate member coupled to the base at the fourth hip joint and coupled to the second leg member at the second hip joint. In another aspect, the robot further includes a first knee joint, a second knee joint, a first ankle joint, a second ankle joint, a third leg member coupled to the first leg member at the first knee joint, a first foot coupled to the third leg member at the first ankle joint, a fourth leg member coupled to the second leg member at the second knee joint, and a second foot coupled to the fourth leg member at the second ankle joint. In another aspect, each of the first knee joint, the second knee joint, the first ankle joint, and the second ankle joint is not included in the set of continuous rotation joints.

In another aspect, the set of continuous rotation joints further includes a first shoulder joint and a second shoulder joint, and the robot further includes a first arm member coupled to the torso via the first shoulder joint, and a second arm member coupled to the torso via the second shoulder joint. In another aspect, the set of continuous rotation joints further includes a third shoulder joint and a fourth shoulder joint, and the robot further includes a first intermediate arm member coupled to the torso at the third shoulder joint and coupled to the first arm member at the first shoulder joint, and a second intermediate arm member coupled to the torso at the fourth shoulder joint and coupled to the second arm member at the second shoulder joint. In another aspect, the robot further includes a first elbow joint, a second elbow joint, a third arm member coupled to the first arm member at the first elbow joint, a first end effector coupled to the third arm member at a first wrist component, a fourth arm member coupled to the second arm member at the second elbow joint, and a second end effector coupled to the fourth arm member at a second wrist component. In another aspect, each of the first elbow joint and the second elbow joint is not included in the set of continuous rotation joints. In another aspect, the first end effector is a first gripper configured to grasp a first portion of a first object, and the second end effector is a second gripper configured to grasp a second portion of the first object or a second object.

In another aspect, the robot further includes a set of actuators associated with the set of continuous rotation joints, and a control system including one or more computer processors. The one or more computer processors are configured to determine a motion plan for the robot to perform a task and control the set of actuators in accordance with the motion plan to perform the task. In another aspect, determining a motion plan comprises determining a motion plan that includes rotating coupled members about respective multiple joints in the set of continuous rotation joints. In another aspect, the base forms a pelvis structure of the robot. In another aspect, the robot is a humanoid robot. In another aspect, a front side and a back side of the torso are symmetric. In another aspect, the robot further includes a fastener coupled to the torso, wherein the fastener is configured to be coupled to an object. In another aspect, the fastener is selected from the group consisting of a rod, a bracket, and a hook.

In some embodiments, the invention features a robot. The robot includes a base, a set of continuous rotation joints, each continuous rotation joint permitting continuous rotation of an attached member about a corresponding axis, and the set of continuous rotation joints includes a first hip joint, a second hip joint, a third hip joint, a fourth hip joint, a first shoulder joint, a second shoulder joint, a third shoulder joint, a fourth shoulder joint, a back joint, and a neck joint. The robot further includes a first leg member coupled to the base via the first hip joint, the third hip joint, and a first intermediate member coupled between the first hip joint and the third hip joint. The robot further includes a second leg member coupled to the base via the second hip joint, the fourth hip joint, and a second intermediate member coupled between the second hip joint and the fourth hip joint. The robot further includes a torso coupled to the base via the back joint, a head coupled to the torso via the neck joint, a first arm member coupled to the torso via the first shoulder joint, the third shoulder joint, and a first intermediate arm member coupled between the first shoulder joint and the third shoulder joint, and a second arm member coupled to the torso via the second shoulder joint, the fourth shoulder joint, and a second intermediate arm member coupled between the second shoulder joint and the fourth shoulder joint.

In one aspect, the robot further includes a third leg member coupled to the first leg member via a first knee joint, a fourth leg member coupled to the second leg member via a second knee joint, a first foot coupled to the third leg member via a first ankle joint, a second foot coupled to the fourth leg member via a second ankle joint, a third arm member coupled to the first arm member via a first elbow joint, and a fourth arm member coupled to the second arm member via a second elbow joint. In another aspect, the robot further includes a first end effector coupled to the third arm member via a first wrist component, and a second end effector coupled to the fourth arm member via a second wrist component. In another aspect, the first end effector is a first gripper configured to grasp a first portion of a first object, and the second end effector is a second gripper configured to grasp a second portion of the first object or a second object. In another aspect, the robot further includes a set of actuators associated with the set of continuous rotation joints, and a control system including one or more computer processors, and the one or more computer processors are configured to determine a motion plan for the robot to perform a task and control the set of actuators in accordance with the motion plan to perform the task. In another aspect, determining a motion plan comprises determining a motion plan that includes rotating coupled members about respective multiple joints in the set of continuous rotation joints. In another aspect, the base forms a pelvis structure of the robot. In another aspect, the robot is a humanoid robot.

In some embodiments, the invention features a method of controlling a robot having a set of continuous rotation joints including a first hip joint coupled to a first leg of the robot, a second hip joint coupled to a second leg of the robot and a back joint coupled to a torso of the robot. The method includes receiving task information to perform a task, the task information specifying the robot to have a first pose at a first location and a second pose at a second location, the second pose being different from the first pose, determining a motion plan for the robot to perform the task. The motion plan includes rotating the first leg of the robot in a first direction about the first hip joint by a first amount that orients a front of the first leg toward the second location, rotating the second leg of the robot in second direction about the second hip joint by a second amount that orients a front of the second leg toward the second location, and rotating the torso about the back joint by a third amount that at least partially moves the robot toward achieving the second pose. The method further includes controlling the robot to move based on the motion plan to perform the task.

In one aspect, the first direction and the second direction are different. In another aspect, the motion plan includes a step plan for the robot, the step plan including a first step and a second step, rotating the first leg is performed during the first step by the first leg, and rotating the second leg is performed during the second step by the second leg. In another aspect, the second step immediately follows the first step in the step plan. In another aspect, the robot further comprises a first foot coupled to the first leg and a second foot coupled to the second leg and rotating the first leg is performed while the first foot is in contact with a surface and the second foot is not in contact with the surface. In another aspect, rotating the second leg is performed while the second foot is not in contact with the surface. In another aspect, rotating the first leg and rotating the second leg are both performed during a step by the second leg. In another aspect, determining a motion plan for the robot comprises determining a motion plan that minimizes time and/or energy while traveling between the first location and the second location. In another aspect, determining a motion plan minimizes time and/or energy while traveling between the first location and the second location comprises determining a motion plan that minimizes a distance of travel of the robot between the first location and the second location. In another aspect, determining a motion plan that minimizes a distance of travel of the robot between the first location and the second location comprises determining a motion plan based on a straight path between the first location and the second location.

In another aspect, rotating the torso about the back joint is performed while the robot moves between the first location and the second location. In another aspect, the set of continuous rotation joints further includes a neck joint coupled between a head of the robot and the torso, and determining the motion plan further includes rotating the head about the neck joint by a fourth amount to achieve a head orientation of the robot in the second pose. In another aspect, the third amount is zero degrees relative to an orientation of the torso in the first pose. In another aspect, the set of continuous rotation joints further includes a first shoulder joint coupled between a first arm and the torso and a second shoulder joint coupled between a second arm and the torso, and determining the motion plan further includes rotating the first arm about the first shoulder joint by a fifth amount to achieve a first arm orientation of the robot in the second pose, and rotating the second arm about the first shoulder joint by a sixth amount to achieve a second arm orientation of the robot in the second pose. In another aspect, rotating the head about the neck joint by a fourth amount is performed prior to rotating the first leg or rotating the second leg. In another aspect, controlling the robot to move based on the motion plan to perform the task comprises controlling the torso to rotate about the back joint at a first speed and controlling the first leg to rotate about the first hip joint at a second speed, the first speed being slower than the second speed.

In another aspect, performing the task includes moving an object from the first location to the second location, and the motion plan further includes grasping the object at the first location and placing the object at the second location. In another aspect, controlling the robot to move based on the motion plan to perform the task comprises controlling the torso to rotate about the back joint independently of rotating the first leg and the second leg.

In some embodiments, the invention features a method of inverting a standing pose of a robot. The method includes rotating a first leg of the robot 180 degrees about a first hip joint, rotating a second leg of the robot 180 degrees about a second hip joint, rotating a first arm of the robot 180 degrees about a first elbow joint, rotating a second arm of the robot 180 degrees about a second elbow joint, and rotating a head of the robot 180 degrees about a neck joint coupling the head to a torso of the robot.

In one aspect, the method further includes controlling the robot to perform a jump from the standing pose, and rotating the first leg and rotating the second leg are performed during the jump. In another aspect, the method further includes controlling the robot to jump from the standing pose, and rotating the first arm and rotating the second arm are performed during the jump. In another aspect, the method further includes controlling the robot to jump from the standing pose, and rotating the head is performed during the jump. In another aspect, the method further includes controlling the robot to jump from the standing pose, and rotating the first leg, rotating the second leg, rotating the first arm, rotating the second arm, and rotating the head are all performed during the jump. In another aspect, the torso of the robot is coupled to a base of the robot via a back joint, and the method further includes simultaneously rotating the torso about a back joint and the neck joint to rotate the torso without rotating the head or the base.

In some embodiments, the invention features a method of controlling a robot to stand from a laying down pose. The method includes moving a first leg of the robot such that a first foot coupled to the first leg is in contact with a surface adjacent to a first side of the robot, moving a second leg of the robot such that a second foot coupled to the second leg is in contact with the surface adjacent to a second side of the robot, and controlling the robot to stand by rotating the first leg relative to a base of the robot and rotating the second leg relative to the base of the robot while the first foot and the second foot remain in contact with the surface.

In one aspect, the first leg is coupled to a base of the robot via a first hip joint, the second leg is coupled to the base of the robot via a second hip joint, moving the first leg of the robot comprises rotating the first leg relative to the base about the first hip joint, and moving the second leg of the robot comprises rotating the second leg relative to the base bout the second hip joint. In another aspect, the first leg includes a first upper leg portion and a first lower leg portion coupled by a first knee joint, the second leg includes a second upper leg portion and a second lower leg portion coupled by a second knee joint, moving the first leg of the robot comprises rotating the first lower leg portion relative to first upper leg portion about the first knee joint, and moving the second leg of the robot comprises rotating the second lower leg portion relative to the second upper leg portion about the second knee joint. In another aspect, a projection of a center of mass of the robot is located within a support polygon defined based, at least in part, on a first location of the first foot on the surface and a second location of the second foot on the surface.

In some embodiments, the inventor features a method of transporting an object by a robot. The method includes grasping an object at a first location in an environment, coupling the object to a fastener on a first side of a torso of the robot, inverting a pose of the robot, and carrying the object to a second location in the environment in the inverted pose.

In one aspect, inverting a pose of the robot comprises inverting an orientation of a first leg of the robot to face toward the second location, inverting an orientation of a second leg of the robot to face toward the second location, and inverting an orientation of a head of the robot to face toward the second location. In another aspect, inverting a pose of the robot comprises rotating the torso such that the first side of the torso is oriented away from a direction of travel toward the second location, while the first leg, the second leg, and a head of the robot remain oriented in the direction of travel toward the second location. In another aspect, the fastener comprises a tooling coupled to the first side of the torso and coupling the object to the fastener comprise resting a portion of the object on the tooling.

In some embodiments, the invention features a method of manipulating an object using a robot. The method includes grasping an object with one or more end effectors of the robot, the object being located on a first side of a torso of the robot and rotating one or more arms of the robot coupled to the one or more end effectors to lift the object over a torso of the robot such that the object is located on a second side of the torso opposite the first side.

In one aspect, grasping an object with one or more end effectors of the robot comprises grasping the object with two end effectors of the robot. In another aspect, rotating one or more arms of the robot coupled to the one or more end effectors is performed without moving the torso. In another aspect, each of the one or more arms of the robot includes an upper arm member and a lower arm member coupled by an elbow joint, the method further comprising inverting each of the one or more arms via rotation at the elbow joint when the object is located on the second side of the torso. In another aspect, the robot includes a head coupled to the torso via a continuous rotation neck joint, wherein the method comprises rotating the head relative to the torso about the continuous rotation neck joint to face the second side.

In some embodiments, the invention features a method of grasping an object using a robot. The method includes inverting a first leg of the robot and a second leg of the robot such that each of a front of the first leg and a front of the second leg faces in a first direction away from an object to be grasped, grasping the object from a surface with one or more end effectors of the robot, while the first leg and the second leg are inverted, and lifting the object from the surface by rotating the first leg and the second leg relative to a base of the robot.

In one aspect, the method further includes rotating a torso relative to the base of the robot to face the object in the first direction.

In some embodiments, the invention features a method of controlling a robot having legs to move laterally. The method includes controlling the robot to take a first lateral step by crossing a first leg of the robot over a second leg of the robot while rotating a pelvis of the robot relative to a torso of the robot about a back joint in a first direction, and controlling the robot to take a second lateral step by uncrossing the second leg from the first leg while rotating the pelvis of the robot relative to the torso of the robot about the back joint in a second direction opposite the first direction.

In some embodiments, the invention features a method of controlling a robot configured to perform extra-human behaviors. The method includes constraining, by a control system of the robot, motion of the robot to a first set of behaviors when in a first mode of operation, the first set of behaviors not including extra-human behaviors, and allowing, by the control system of the robot, motion of the robot to include the first set of behaviors and the extra-human behaviors when in a second mode of operation.

In one aspect, the method further includes receiving a first indication that a human is near and/or observing the robot and controlling the robot to operate in the first mode of operation in response to receiving the first indication. In another aspect, the method further includes receiving a second indication that a human is not near and/or observing the robot and controlling the robot to operate in the second mode of operation in response to receiving the second indication.

In some embodiments, the invention features a robot. The robot includes a torso, a pelvis coupled to the torso at a first continuous rotation joint, a first leg coupled to the pelvis at a second continuous rotation joint, a second leg coupled to the pelvis at a third continuous rotation joint, and a control system configured to control rotation of the first continuous rotation joint, the second continuous rotation joint and the third continuous rotation joint based, at least in part, on a motion plan for the robot.

In one aspect, the first continuous rotation joint, the second continuous rotation joint and the third continuous rotation joint enable the robot to perform omnidirectional stepping. In another aspect, the motion plan includes a step plan, and the control system is configured to determine the step plan.

In some embodiments, the invention features a robot. The robot includes a body and a plurality of kinematic chains of robot members coupled to the body, each of the plurality of kinematic chains of robot members having at least two joints, wherein at least one of the at least two joints is a continuous rotation joint.

In one aspect, the body includes a torso, and a pelvis coupled to the torso at a continuous rotation joint. In another aspect, the plurality of kinematic chains of robot members includes a first kinematic chain of robot members coupled to the pelvis and a second kinematic chain of robot members coupled to the pelvis. In another aspect, the at least two joints for the first kinematic chain includes a first continuous rotation joint coupling the first kinematic chain to the pelvis, and the at least two joints for the second kinematic chain includes a second continuous rotation joint coupling the second kinematic chain to the pelvis. In another aspect, the plurality of kinematic chains of robot members further includes a third kinematic chain of robot members coupled to the torso, and a fourth kinematic chain of robot members coupled to the torso. In another aspect, the at least two joints for the third kinematic chain includes a first continuous rotation joint coupling the third kinematic chain to the torso, and the at least two joints for the fourth kinematic chain includes a second continuous rotation joint coupling the fourth kinematic chain to the torso.

In some embodiments, the invention features a computer-implemented method. The method including receiving, by a computing system of a robot, task information to perform a task, and determining, based at least in part on the task information and kinematic information associated with joints and members of the robot, a set of trajectories for the robot to perform the task, wherein at least one of the joints used to perform the task is a continuous rotation joint that permits continuous rotation of an attached member about an axis.

In one aspect, the task information includes a set of footstep locations and pelvis rotations for performing locomotion of the robot.

### BRIEF DESCRIPTION OF DRAWINGS

The advantages of the invention, together with further advantages, may be better understood by referring to the following description taken in conjunction with the accompanying drawings. The drawings are not necessarily to scale, and emphasis is instead generally placed upon illustrating the principles of the invention.

FIG. 1 illustrates an example configuration of a robotic device, according to an illustrative embodiment of the invention.

FIG. 2A illustrates an example of a humanoid robot, according to an illustrative embodiment of the invention.

FIG. 2B illustrates an example of various actuators of a humanoid robot, according to an illustrative embodiment of the invention.

FIG. 3 is a flowchart of a computer-implemented process, according to an illustrative embodiment of the invention.

FIG. 4 schematically illustrates a robot performing extra-human turning behaviors, according to an illustrative embodiment of the invention.

FIGS. 5A-5E illustrate an example standup behavior for a robot, according to an illustrative embodiment of the invention.

FIGS. 6A-6D illustrate an example object carrying behavior for a robot, according to an illustrative embodiment of the invention.

FIGS. 7A-7F illustrate an example pick and place behavior for a robot, according to an illustrative embodiment of the invention.

FIGS. 8A-8F illustrate another example pick and place behavior for a robot, according to an illustrative embodiment of the invention.

FIGS. 9A-9F illustrate an example object lifting behavior for a robot, according to an illustrative embodiment of the invention.

FIGS. 10A-10F illustrate an example turn and walk behavior for a robot, according to an illustrative embodiment of the invention.

FIGS. 11A-11F illustrate an example jump inversion behavior for a robot, according to an illustrative embodiment of the invention.

FIG. 12A schematically illustrates an available step region for a foot of a conventional legged robot.

FIG. 12B schematically illustrates an available step region for a foot of a legged robot, according to an illustrative embodiment of the invention.

FIGS. 13A-13D illustrate an example omnidirectional stepping behavior for a robot, according to an illustrative embodiment of the invention.

FIGS. 14A-14E illustrate an example cross stepping behavior for a robot, according to an illustrative embodiment of the invention.

FIGS. 15A-15F illustrate an example twist stepping behavior for a robot, according to an illustrative embodiment of the invention.

FIG. 16 is a flowchart of a computer-implemented process, according to an illustrative embodiment of the invention.

### DETAILED DESCRIPTION

An example implementation involves a robotic device configured with at least one robotic limb, one or more sensors, and a processing system. The robotic limb may be an articulated robotic appendage including a number of members connected by joints. The robotic limb may also include a number of actuators (e.g., 2-5 actuators) coupled to the members of the limb that facilitate movement of the robotic limb through a range of motion limited by the joints connecting the members. The sensors may be configured to measure properties of the robotic device, such as angles of the joints, pressures within the actuators, joint torques, and/or positions, velocities, and/or accelerations of members of the robotic limb(s) at a given point in time. The sensors may also be configured to measure an orientation (e.g., a body orientation measurement) of the body of the robotic device (which may also be referred to herein as the “base” of the robotic device). Other example properties include the masses of various components of the robotic device, among other properties. The processing system of the robotic device may determine the angles of the joints of the robotic limb, either directly from angle sensor information or indirectly from other sensor information from which the joint angles can be calculated. The processing system may then estimate an orientation of the robotic device based on the sensed orientation of the base of the robotic device and the joint angles.

An orientation may herein refer to an angular position of an object. In some instances, an orientation may refer to an amount of rotation (e.g., in degrees or radians) about three axes. In some cases, an orientation of a robotic device may refer to the orientation of the robotic device with respect to a particular reference frame, such as the ground or a surface on which it stands. An orientation may describe the angular position using Euler angles, Tait-Bryan angles (also known as yaw, pitch, and roll angles), and/or Quaternions. In some instances, such as on a computer-readable medium, the orientation may be represented by an orientation matrix and/or an orientation quaternion, among other representations.

In some scenarios, measurements from sensors on the base of the robotic device may indicate that the robotic device is oriented in such a way and/or has a linear and/or angular velocity that requires control of one or more of the articulated appendages in order to maintain balance of the robotic device. In these scenarios, however, it may be the case that the limbs of the robotic device are oriented and/or moving such that balance control is not required. For example, the body of the robotic device may be tilted to the left, and sensors measuring the body's orientation may thus indicate a need to move limbs to balance the robotic device; however, one or more limbs of the robotic device may be extended to the right, causing the robotic device to be balanced despite the sensors on the base of the robotic device indicating otherwise. The limbs of a robotic device may apply a torque on the body of the robotic device and may also affect the robotic device's center of mass. Thus, orientation and angular velocity measurements of one portion of the robotic device may be an inaccurate representation of the orientation and angular velocity of the combination of the robotic device's body and limbs (which may be referred to herein as the “aggregate” orientation and angular velocity).

In some implementations, the processing system may be configured to estimate the aggregate orientation and/or angular velocity of the entire robotic device based on the sensed orientation of the base of the robotic device and the measured joint angles. The processing system has stored thereon a relationship between the joint angles of the robotic device and the extent to which the joint angles of the robotic device affect the orientation and/or angular velocity of the base of the robotic device. The relationship between the joint angles of the robotic device and the motion of the base of the robotic device may be determined based on the kinematics and mass properties of the limbs of the robotic devices. In other words, the relationship may specify the effects that the joint angles have on the aggregate orientation and/or angular velocity of the robotic device. Additionally, the processing system may be configured to determine components of the orientation and/or angular velocity of the robotic device caused by internal motion and components of the orientation and/or angular velocity of the robotic device caused by external motion. Further, the processing system may differentiate components of the aggregate orientation in order to determine the robotic device's aggregate yaw rate, pitch rate, and roll rate (which may be collectively referred to as the “aggregate angular velocity”).

In some implementations, the robotic device may also include a control system that is configured to control the robotic device on the basis of a simplified model of the robotic device. The control system may be configured to receive the estimated aggregate orientation and/or angular velocity of the robotic device, and subsequently control one or more jointed limbs of the robotic device to behave in a certain manner (e.g., maintain the balance of the robotic device). For instance, the control system may determine locations at which to place the robotic device's feet and/or the force to exert by the robotic device's feet on a surface based on the aggregate orientation.

In some implementations, the robotic device may include force sensors that measure or estimate the external forces (e.g., the force applied by a leg of the robotic device against the ground) along with kinematic sensors to measure the orientation of the limbs of the robotic device. The processing system may be configured to determine the robotic device's angular momentum based on information measured by the sensors. The control system may be configured with a feedback-based state observer that receives the measured angular momentum and the aggregate angular velocity, and provides a reduced-noise estimate of the angular momentum of the robotic device. The state observer may also receive measurements and/or estimates of torques or forces acting on the robotic device and use them, among other information, as a basis to determine the reduced-noise estimate of the angular momentum of the robotic device.

The control system may be configured to actuate one or more actuators connected across components of a robotic leg. The actuators may be controlled to raise or lower the robotic leg. In some cases, a robotic leg may include actuators to control the robotic leg's motion in three dimensions. Depending on the particular implementation, the control system may be configured to use the aggregate orientation, along with other sensor measurements, as a basis to control the robot in a certain manner (e.g., stationary balancing, walking, running, galloping, etc.).

In some implementations, multiple relationships between the joint angles and their effect on the orientation and/or angular velocity of the base of the robotic device may be stored on the processing system. The processing system may select a particular relationship with which to determine the aggregate orientation and/or angular velocity based on the joint angles. For example, one relationship may be associated with a particular joint being between 0 and 90 degrees, and another relationship may be associated with the particular joint being between 91 and 180 degrees. The selected relationship may more accurately estimate the aggregate orientation of the robotic device than the other relationships.

In some implementations, the processing system may have stored thereon more than one relationship between the joint angles of the robotic device and the extent to which the joint angles of the robotic device affect the orientation and/or angular velocity of the base of the robotic device. Each relationship may correspond to one or more ranges of joint angle values (e.g., operating ranges). In some implementations, the robotic device may operate in one or more modes. A mode of operation may correspond to one or more of the joint angles being within a corresponding set of operating ranges. In these implementations, each mode of operation may correspond to a certain relationship.

The angular velocity of the robotic device may have multiple components describing the robotic device's orientation (e.g., rotational angles) along multiple planes. From the perspective of the robotic device, a rotational angle of the robotic device turned to the left or the right may be referred to herein as “yaw.” A rotational angle of the robotic device upwards or downwards may be referred to herein as “pitch.” A rotational angle of the robotic device tilted to the left or the right may be referred to herein as “roll.” Additionally, the rate of change of the yaw, pitch, and roll may be referred to herein as the “yaw rate,” the “pitch rate,” and the “roll rate,” respectively.

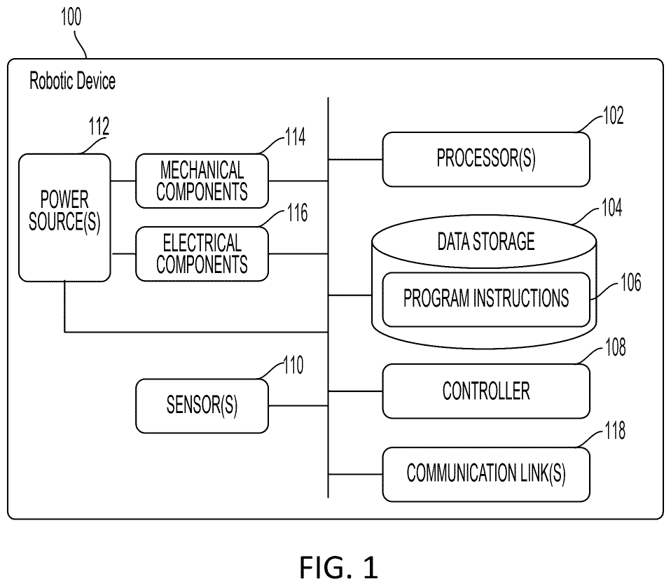

Referring now to the figures, FIG. 1 illustrates an example configuration of a robotic device (or “robot”) 100, according to an illustrative embodiment of the invention. The robotic device 100 represents an example robotic device configured to perform the operations described herein. Additionally, the robotic device 100 may be configured to operate autonomously, semi-autonomously, and/or using directions provided by user(s), and may exist in various forms, such as a humanoid robot, biped, quadruped, or other mobile robot, among other examples. Furthermore, the robotic device 100 may also be referred to as a robotic system, mobile robot, or robot, among other designations.

As shown in FIG. 1, the robotic device 100 includes processor(s) 102, data storage 104, program instructions 106, controller 108, sensor(s) 110, power source(s) 112, mechanical components 114, and electrical components 116. The robotic device 100 is shown for illustration purposes and may include more or fewer components without departing from the scope of the disclosure herein. The various components of robotic device 100 may be connected in any manner, including via electronic communication means, e.g., wired or wireless connections. Further, in some examples, components of the robotic device 100 may be positioned on multiple distinct physical entities rather on a single physical entity. Other example illustrations of robotic device 100 may exist as well.

Processor(s) 102 may operate as one or more general-purpose processor or special purpose processors (e.g., digital signal processors, application specific integrated circuits, etc.). The processor(s) 102 can be configured to execute computer-readable program instructions 106 that are stored in the data storage 104 and are executable to provide the operations of the robotic device 100 described herein. For instance, the program instructions 106 may be executable to provide operations of controller 108, where the controller 108 may be configured to cause activation and/or deactivation of the mechanical components 114 and the electrical components 116. The processor(s) 102 may operate and enable the robotic device 100 to perform various functions, including the functions described herein.

The data storage 104 may exist as various types of storage media, such as a memory. For example, the data storage 104 may include or take the form of one or more computer-readable storage media that can be read or accessed by processor(s) 102. The one or more computer-readable storage media can include volatile and/or non-volatile storage components, such as optical, magnetic, organic or other memory or disc storage, which can be integrated in whole or in part with processor(s) 102. In some implementations, the data storage 104 can be implemented using a single physical device (e.g., one optical, magnetic, organic or other memory or disc storage unit), while in other implementations, the data storage 104 can be implemented using two or more physical devices, which may communicate electronically (e.g., via wired or wireless communication). Further, in addition to the computer-readable program instructions 106, the data storage 104 may include additional data such as diagnostic data, among other possibilities.

The robotic device 100 may include at least one controller 108, which may interface with the robotic device 100. The controller 108 may serve as a link between portions of the robotic device 100, such as a link between mechanical components 114 and/or electrical components 116. In some instances, the controller 108 may serve as an interface between the robotic device 100 and another computing device. Furthermore, the controller 108 may serve as an interface between the robotic device 100 and a user(s). The controller 108 may include various components for communicating with the robotic device 100, including one or more joysticks or buttons, among other features. The controller 108 may perform other operations for the robotic device 100 as well. Other examples of controllers may exist as well.

Additionally, the robotic device 100 includes one or more sensor(s) 110 such as force sensors, proximity sensors, motion sensors, load sensors, position sensors, touch sensors, depth sensors, ultrasonic range sensors, and/or infrared sensors, among other possibilities. The sensor(s) 110 may provide sensor data to the processor(s) 102 to allow for appropriate interaction of the robotic device 100 with the environment as well as monitoring of operation of the systems of the robotic device 100. The sensor data may be used in evaluation of various factors for activation and deactivation of mechanical components 114 and electrical components 116 by controller 108 and/or a computing system of the robotic device 100.

The sensor(s) 110 may provide information indicative of the environment of the robotic device for the controller 108 and/or computing system to use to determine operations for the robotic device 100. For example, the sensor(s) 110 may capture data corresponding to the terrain of the environment or location of nearby objects, which may assist with environment recognition and navigation, etc. In an example configuration, the robotic device 100 may include a sensor system that may include a camera, RADAR, LIDAR, time-of-flight camera, global positioning system (GPS) transceiver, and/or other sensors for capturing information of the environment of the robotic device 100. The sensor(s) 110 may monitor the environment in real-time and detect obstacles, elements of the terrain, weather conditions, temperature, and/or other parameters of the environment for the robotic device 100.

Further, the robotic device 100 may include other sensor(s) 110 configured to receive information indicative of the state of the robotic device 100, including sensor(s) 110 that may monitor the state of the various components of the robotic device 100. The sensor(s) 110 may measure activity of systems of the robotic device 100 and receive information based on the operation of the various features of the robotic device 100, such the operation of extendable legs, arms, or other mechanical and/or electrical features of the robotic device 100. The sensor data provided by the sensors may enable the computing system of the robotic device 100 to determine errors in operation as well as monitor overall functioning of components of the robotic device 100.

For example, the computing system may use sensor data to determine the stability of the robotic device 100 during operations as well as measurements related to power levels, communication activities, components that require repair, among other information. As an example configuration, the robotic device 100 may include gyroscope(s), accelerometer(s), and/or other possible sensors to provide sensor data relating to the state of operation of the robotic device. Further, sensor(s) 110 may also monitor the current state of a function, such as a gait, that the robotic device 100 may currently be operating. Additionally, the sensor(s) 110 may measure a distance between a given robotic leg of a robotic device and a center of mass of the robotic device. Other example uses for the sensor(s) 110 may exist as well.

Additionally, the robotic device 100 may also include one or more power source(s) 112 configured to supply power to various components of the robotic device 100. Among possible power systems, the robotic device 100 may include a hydraulic system, electrical system, batteries, and/or other types of power systems. As an example illustration, the robotic device 100 may include one or more batteries configured to provide power to components via a wired and/or wireless connection. Within examples, components of the mechanical components 114 and electrical components 116 may each connect to a different power source or may be powered by the same power source. Components of the robotic device 100 may connect to multiple power sources as well.

Within example configurations, any type of power source may be used to power the robotic device 100, such as a gasoline and/or electric engine. Further, the power source(s) 112 may charge using various types of charging, such as wired connections to an outside power source, wireless charging, combustion, or other examples. Other configurations may also be possible. Additionally, the robotic device 100 may include a hydraulic system configured to provide power to the mechanical components 114 using fluid power. Components of the robotic device 100 may operate based on hydraulic fluid being transmitted throughout the hydraulic system to various hydraulic motors and hydraulic cylinders, for example. The hydraulic system of the robotic device 100 may transfer a large amount of power through small tubes, flexible hoses, or other links between components of the robotic device 100. Other power sources may be included within the robotic device 100.

Mechanical components 114 can represent hardware of the robotic device 100 that may enable the robotic device 100 to operate and perform physical functions. As a few examples, the robotic device 100 may include actuator(s), extendable leg(s) (“legs”), arm(s), wheel(s), one or multiple structured bodies for housing the computing system or other components, and/or other mechanical components. The mechanical components 114 may depend on the design of the robotic device 100 and may also be based on the functions and/or tasks the robotic device 100 may be configured to perform. As such, depending on the operation and functions of the robotic device 100, different mechanical components 114 may be available for the robotic device 100 to utilize. In some examples, the robotic device 100 may be configured to add and/or remove mechanical components 114, which may involve assistance from a user and/or other robotic device. For example, the robotic device 100 may be initially configured with four legs, but may be altered by a user or the robotic device 100 to remove two of the four legs to operate as a biped. Other examples of mechanical components 114 may be included.

The electrical components 116 may include various components capable of processing, transferring, providing electrical charge or electric signals, for example. Among possible examples, the electrical components 116 may include electrical wires, circuitry, and/or wireless communication transmitters and receivers to enable operations of the robotic device 100. The electrical components 116 may interwork with the mechanical components 114 to enable the robotic device 100 to perform various operations. The electrical components 116 may be configured to provide power from the power source(s) 112 to the various mechanical components 114, for example. Further, the robotic device 100 may include electric motors. Other examples of electrical components 116 may exist as well.

In some implementations, the robotic device 100 may also include communication link(s) 118 configured to send and/or receive information. The communication link(s) 118 may transmit data indicating the state of the various components of the robotic device 100. For example, information read in by sensor(s) 110 may be transmitted via the communication link(s) 118 to a separate device. Other diagnostic information indicating the integrity or health of the power source(s) 112, mechanical components 114, electrical components 116, processor(s) 102, data storage 104, and/or controller 108 may be transmitted via the communication link(s) 118 to an external communication device.

In some implementations, the robotic device 100 may receive information at the communication link(s) 118 that is processed by the processor(s) 102. The received information may indicate data that is accessible by the processor(s) 102 during execution of the program instructions 106, for example. Further, the received information may change aspects of the controller 108 that may affect the behavior of the mechanical components 114 or the electrical components 116. In some cases, the received information indicates a query requesting a particular piece of information (e.g., the operational state of one or more of the components of the robotic device 100), and the processor(s) 102 may subsequently transmit that particular piece of information back out the communication link(s) 118.

In some cases, the communication link(s) 118 include a wired connection. The robotic device 100 may include one or more ports to interface the communication link(s) 118 to an external device. The communication link(s) 118 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

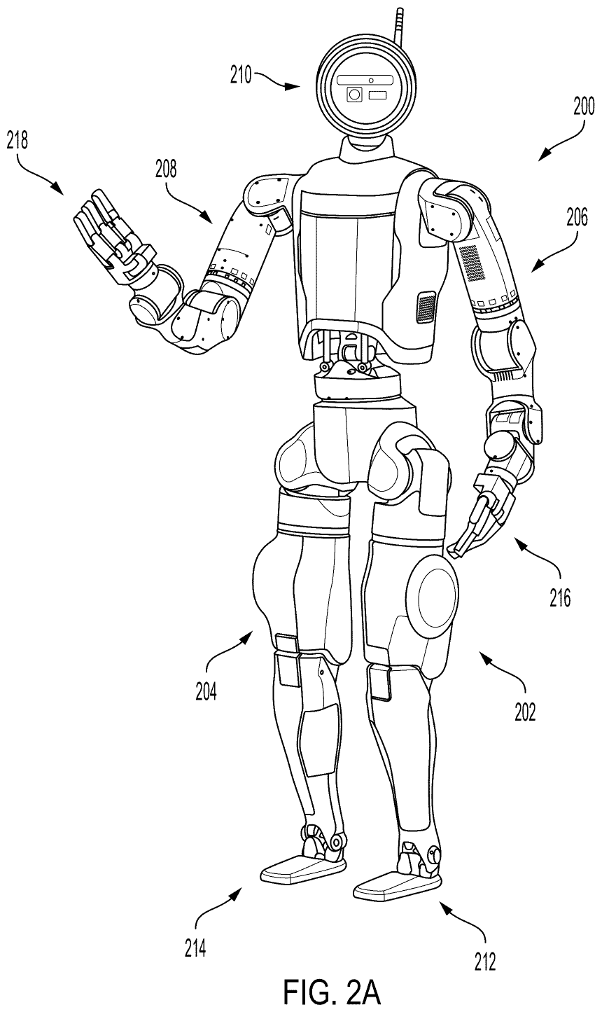

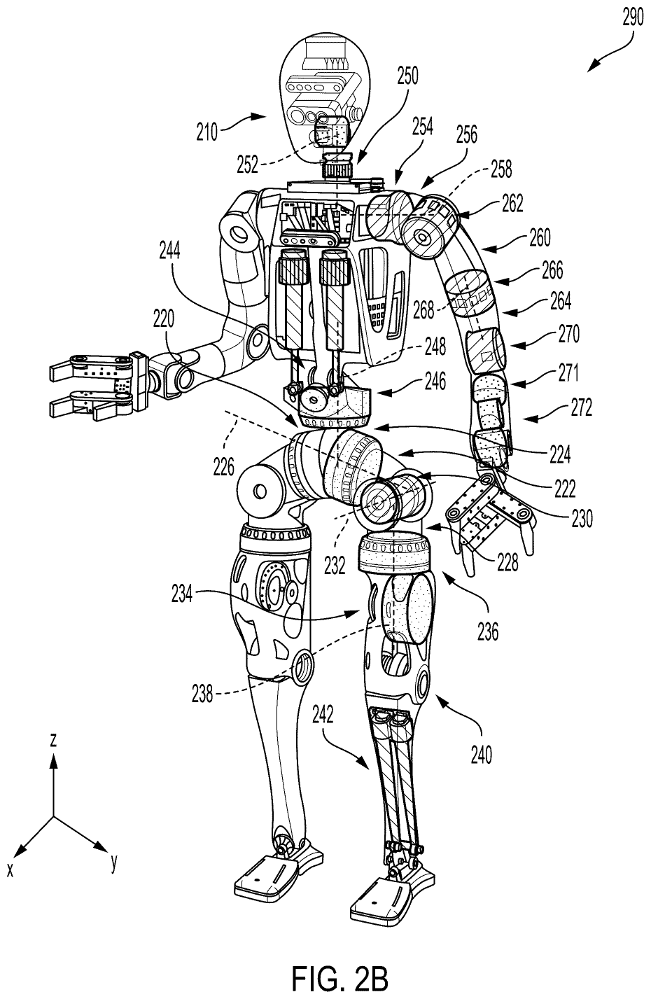

FIG. 2A illustrates an example of a humanoid robot, according to an illustrative embodiment of the invention. The robot 200 may correspond to the robotic device 100 shown in FIG. 1. The robot 200 serves as a possible implementation of a robotic device that may be configured to include the systems and/or carry out the methods described herein. Other example implementations of robotic devices may exist.

The robot 200 may include a number of articulated appendages, such as robotic legs 202, 204 and/or robotic arms 206, 208. The robot 200 may also include a robotic head 210, which may contain one or more vision sensors (e.g., cameras, infrared sensors, object sensors, range sensors, etc.). Each articulated appendage may include a number of (e.g., one, two, three or more) members connected by joints that allow the articulated appendage to move through certain degrees of freedom. For example, each robotic leg 202, 204 may include a respective foot 212, 214, which may contact a surface (e.g., a ground surface). The legs 202, 204 may enable the robot 200 to travel at various speeds according to various gaits. In addition, each robotic arm 206, 208 may facilitate object manipulation, load carrying, and/or balancing of the robot 200. Each arm 206, 208 may also include one or more members connected by joints and may be configured to operate with various degrees of freedom. Each arm 206, 208 may also include a respective end effector (e.g., gripper, hand, etc.) 216, 218. The robot 200 may use end effectors 216, 218 for interacting with (e.g., gripping, turning, pulling, and/or pushing) objects. Each end effector 216, 218 may include various types of appendages or attachments, such as fingers, attached tools or grasping mechanisms. In some embodiments, one or more sensors (e.g., cameras, infrared sensors, object sensors, range sensors, etc.) may be arranged on an arbitrary member or link of the robot.

Robot 200 may also include sensors to measure the angles of the joints of its articulated appendages. In addition, the articulated appendages may include a number of actuators that can be controlled to extend and retract members of the articulated appendages. Examples of actuators that may be included in robot 200 are described in more detail in FIG. 2B. In some cases, the angle of a joint may be determined based on the extent of protrusion or retraction of a given actuator. In some instances, the joint angles may be inferred from position data of inertial measurement units (IMUs) mounted on the members of an articulated appendage. In some implementations, the joint angles may be measured using rotary position sensors, such as rotary encoders. In other implementations, the joint angles may be measured using optical reflection techniques. Other joint angle measurement techniques may also be used.

In some embodiments, robot 200 may include a set of continuous rotation joints, where each continuous rotation joint permits continuous (e.g., 360 degree and/or limitless) rotation about a corresponding axis. Rather than requiring such joints to “unwind” by, for example, always determining a target joint angle relative to a nominal (e.g., 0 degree) orientation, a control system of the robot 200 may be configured to determine that the target joint angle be set at any multiple of 360 degrees (e.g., 0 degrees, 360 degrees, 720 degrees) to permit efficient movement of an attached member about the joint to achieve the target joint angle. For instance, if a target joint angle of a continuous rotation joint is 15 degrees and the current joint angle is 350 degrees, rather that rotating an attached member −335 degrees about the joint, the attached member can instead be rotated+25 degrees (to 375 degrees), which is equivalent to a joint angle of 15 degrees for a continuous rotation joint.

In some embodiments, robot 200 may include a body (e.g., a torso and a base such as a pelvis base) and one or more kinematic chains of robot members (e.g., arms, legs) coupled to the body. Each of the plurality of kinematic chains of robot members may include at least two joints (e.g., a first joint coupling the kinematic chain to the body and a second joint coupling at least two members of the kinematic chain). At least one of the at least two joints in a kinematic chain may be a continuous rotation joint that enables continuous rotation of at least one of the members (and possibly all members if the joint that couples the kinematic member to the body is a continuous rotation joint) of the kinematic chain about the joint.

Robot 200 may be configured to send sensor data from the articulated appendages to a device coupled to robot 200 such as a processing system, a computing system, or a control system. Robot 200 may include a memory, either included in a device on robot 200 or as a standalone component, on which sensor data is stored. In some implementations, the sensor data is retained in the memory for a certain amount of time. In some cases, the stored sensor data may be processed or otherwise transformed for use by a control system on robot 200. In some cases, robot 200 may also transmit the sensor data over a wired or wireless connection (or other electronic communication means) to an external device.

FIG. 2B illustrates an example of a humanoid robot 290, according to an illustrative embodiment of the invention. Humanoid robot 290 may include components (e.g., arms, legs, feet, head) similar to robot 200 of FIG. 2A, which may not be relabeled in FIG. 2B to reduce clutter. Overlaid on the depiction of humanoid robot 290 are a set of actuators that may be used to move an attached member at corresponding joints of the humanoid robot 290 to enable movement of the robot. As described in more detail below, humanoid robot 290 may include different types of actuators and joints that enable different members of the robot to move with varying degrees of freedom, permitting flexibility of movement when desired while restricting movement as appropriate to, for example, avoid or reduce the risk of collisions between robot components.

Humanoid robot 290 includes a base member (e.g., a pelvis base, as shown in FIG. 2B) 220. The pelvis base 220 is rotatably connected to a first hip member 222. An electric actuator 224 may be disposed between the pelvis base 220 and the first hip member 222 (e.g., in, between, connected to, and/or as part of one or both components). In some embodiments, a first portion of the electric actuator 224 may be fixed to the pelvis base 220, and a second portion of the electric actuator 224 may be fixed to the first hip member 222. The electric actuator 224 may be configured to rotate the pelvis base 220 relative to the first hip member 222 about an axis (e.g., a first hip-y axis) 226. The first hip member 222 is also connected to a first intermediate leg member 228. An electric actuator 230 may be disposed between the first hip member 222 and the first intermediate leg member 228 (e.g., in, between, connected to, and/or as part of one or both components). In some embodiments, a first portion of the electric actuator 230 may be fixed to the first hip member 222, and a second portion of the electric actuator 230 may be fixed to the first intermediate leg member 228. The electric actuator 230 may be configured to rotate the first hip member 222 relative to the first intermediate leg member 228 about an axis (e.g., a first hip-x axis) 232. The first intermediate leg member 228 is also connected to a first leg member 234. An electric actuator 236 may be disposed between the first intermediate member 228 and the first leg member 234 (e.g., in, between, connected to, and/or as part of one or both components). In some embodiments, a first portion of the electric actuator 236 may be fixed to the first intermediate member 228, and a second portion of the electric actuator 236 may be fixed to the first leg member 234. The electric actuator 236 may be configured to rotate the first intermediate leg member 228 relative to the first leg member 234 about an axis (e.g., a first hip-z axis) 238. In some embodiments, a second hip member, second intermediate leg member, and second leg member are connected in similar fashion to the first hip member, first intermediate leg member, and first leg member, using similar actuators rotating along similar additional axes and/or providing similar independently actuatable degrees of freedom.

The axis 226 may be referred to as a first hip-y axis, which denotes a flexion/extension axis of the robot 200. The axis 232 may be referred to as a first hip-x axis, which denotes an abduction/adduction axis. The axis 238 may be referred to as a first hip-z axis, which denotes a pronation/supination axis. FIG. 2B shows a set of reference axes to illustrate the x, y and z directions, although the actual x, y, and z axes in the robot 200 need not be mutually orthogonal or extend from the same origin. In some embodiments, rotation about the first hip-y axis 226 may cause the robot leg 202 to swing upward and backward (e.g., in a direction that would enable the robot 200 to walk forward and backward). In some embodiments, rotation about the first hip-x axis 232 may cause the robot leg 202 to swing inward (e.g., toward a center line between the legs 202, 204 of the robot 200) and outward. In some embodiments, rotation about the first hip-z axis may cause the robot leg 202 to rotate the stance of the leg (e.g., twist it to the left or to the right). In some embodiments, the leg member 234 is an upper leg member, which may in turn be connected to a lower leg member 242 at a knee joint 240. In some embodiments, the lower leg member 242 is connected to a foot (e.g., foot 212) at an ankle joint.

In some embodiments, the pelvis base 220 is rotatably connected and/or configured to be rotatably connected to a back member 244 (also referred to herein as a “torso”) of the robot 290. An electric actuator 246 may be disposed between the pelvis base 220 and the back member 244 (e.g., in, between, connected to, and/or part of one or both components). In some embodiments, a first portion of the electric actuator 246 may be fixed to the pelvis base 220, and a second portion of the electric actuator 246 may be fixed to the back member 244. The electric actuator 246 may be configured to rotate the back member 244 relative to pelvis base 220 about an axis (e.g., back-z axis) 248. In some embodiments, the back member 244 is rotatably connected and/or configured to be rotatably connected to a head 210 of the robot 290. An electric actuator 250 may be disposed between the back member 244 and the head 210 (e.g., in, between, connected to, and/or part of one or both components). In some embodiments, a first portion of the electric actuator 250 may be fixed to the head 210 and a second portion of the electric actuator 250 may be fixed to the back member 244. The electric actuator 250 may be configured to rotate the head 210 relative to the back member 244 about an axis (e.g., neck-z axis) 252.

In some embodiments, a first shoulder member 256 is rotatably connected and/or configured to be rotatably connected to a back member 244 of the robot 290. An electric actuator 254 may be disposed between the back member 244 and the first shoulder member 256 (e.g., in, between, connected to, and/or part of one or both components). In some embodiments, a first portion of the electric actuator 254 may be fixed to the first shoulder member 256, and a second portion of the electric actuator 254 may be fixed to the back member 244. The electric actuator 254 may be configured to rotate the first shoulder member 256 relative to the back member 244 about an axis (e.g., shoulder-y axis) 258. In some embodiments, the first shoulder member 256 is rotatably connected and/or configured to be rotatably connected to a first intermediate arm member 260 of the robot 290. An electric actuator 262 may be disposed between the first shoulder member 256 and the first intermediate arm member 260 (e.g., in, between, connected to, and/or part of one or both components). In some embodiments, a first portion of the electric actuator 262 may be fixed to the first intermediate arm member 260, and a second portion of the electric actuator 262 may be fixed to the first shoulder member 256. The electric actuator 262 may be configured to rotate the first intermediate arm member 260 relative to the first shoulder member 256 about an axis to provide adduction/abduction of the first intermediate arm member 260 relative to the first shoulder member 256. In some embodiments, a first upper arm member 264 is rotatably connected and/or configured to be rotatably connected to the first intermediate arm member 260 of the robot 290. An electric actuator 266 may be disposed between the first arm member 264 and the first intermediate arm member 260 (e.g., in, between, connected to, and/or part of one or both components). In some embodiments, a first portion of the electric actuator 266 may be fixed to the first arm member 264, and a second portion of the electric actuator 266 may be fixed to the first intermediate arm member 260. The electric actuator 266 may be configured to rotate the first arm member 264 relative to the first intermediate arm member 260 about an axis (e.g., shoulder-z axis) 268.

In some embodiments, the first arm member 264 may in turn be connected to a first lower arm member 272 at a first elbow joint. An electric actuator 270 may be disposed between the first arm member 264 and the first lower arm member 272 (e.g., in, between, connected to, and/or part of one or both components). In some embodiments, a first portion of the electric actuator 270 may be fixed to the first arm member 264, and a second portion of the electric actuator 270 may be fixed to the first lower arm member 272. The electric actuator 270 may be configured to rotate the first arm member 264 relative to the first lower arm member 272 about an axis that provides flexion/extension of the first lower arm member 272 relative to the first arm member 264. In some embodiments, rotation about the first elbow joint may be greater than 90 degrees. In some embodiments, rotation about the first elbow joint may be greater than 180 degrees. In some embodiments, rotation about the first elbow joint may permit the first lower arm member 272 to be “inverted” in accordance with one or more extra-human behaviors, examples of which are described herein.

In some embodiments, the first lower arm member 272 is connected to an end effector (e.g., a gripper or hand) via a wrist component. The wrist component may contain one or more actuators configured to provide various ranges of motion to the wrist of the robot. In some embodiments, a second shoulder member, second intermediate arm member, second upper arm member, and second lower arm member are connected in similar fashion to the first shoulder member, first intermediate arm member, first upper arm member, and first lower arm member using similar actuators rotating along similar additional axes and/or providing similar independently actuatable degrees of freedom.

In some embodiments, some or all of the rotations about the joints of robot 290 may be independently controllable. In some embodiments, some or all of the rotations about the joints of robot 290 may collectively enable the robot to reproduce a wide range of motion in three dimensions (e.g., similar to or greater than that achievable by a human). In some embodiments, one or more joints of robot 290 may have a range of motion that exceeds the range of motion of a corresponding human joint. The inventors have recognized and appreciated that the inclusion of joints that have ranges of motion that exceed the capabilities of corresponding human joints (provided that such a similarly-located human joint exists) enable humanoid robot 290 to perform behaviors that are not practical or possible for a human to perform. Such behaviors are referred to herein as “extra-human behaviors.”

As an example, rotation about a human elbow joint may be constrained to a range of approximately 0 degrees (lower arm at full extension) to 135 degrees (lower arm at full flexion). By contrast, rotation about an elbow joint of a robot according to some embodiments may be configured to have a range of motion that exceeds 135 degrees (e.g., substantially exceeds and/or exceeds by an arbitrary amount) to enable the arm of the robot to move into an inverted position (e.g., past lower arm full extension). Such an extended range of motion of the elbow joint may enable the robot to, for example, reach behind the robot without rotating about the shoulder joint, invert the arms to enable the robot to efficiently change its workspace, etc.

In some embodiments, one or more joints of robot 290 may be continuously rotatable (e.g., 360 degrees and/or limitless) about its corresponding axis. For instance, a 180 degree rotation of first leg member 234 relative to first intermediate member 228 about first hip-z axis 238 (also referred to herein as a “hip-z rotation”) enables the first leg member 234 and its corresponding lower leg portions (e.g., knee, ankle, foot) to face the opposite direction as the other leg of robot 290. Because humans do not have a similarly-located joint that permits 180 degree rotation of the leg, such a behavior is not possible for humans to perform. As described herein, extra-human behaviors achievable by a robot (e.g., a humanoid robot) designed in accordance with the embodiments described herein may enable the robot to complete tasks in a different and/or more efficient manner than if the robot only included joints found in a human and/or rotation about the joints of the robot were restricted to having human-like ranges of motion.

The humanoid robot 290 shown in FIG. 2B includes twelve continuous rotation joints (five of which are not explicitly shown for brevity). For example, humanoid robot 290 includes two “hip-z” joints actuated by electric actuators 236, two “hip-y” joints actuated by electric actuators 224, a “back-z” joint actuated by electric actuator 246, a “neck-z” joint actuated by electric actuator 250, two “shoulder-y” joints actuated by electric actuators 254, two “shoulder-z” joints actuated by electric actuators 266, and two “forearm-twist” joints actuated by electric actuators 271. The other joints (e.g., knee joint, elbow joint, ankle joint, hip-x joint, shoulder-x joint) of humanoid robot 290 may have a constrained range of motion so as not to permit continuous rotation about its corresponding axis. However, as described above, even if not permitting continuous rotation, some of those joints (e.g., the elbow joints) may permit rotation within a range that exceeds the range of motion of corresponding human joints, which may facilitate the performance of extra-human behaviors by the robot 290. Although humanoid robot 290 includes twelve continuous rotation joints, some embodiments of the present invention may include fewer or additional continuous rotation joints. For example, in one embodiment, a robot (e.g., a humanoid robot) includes at least two continuous rotation joints (e.g., a continuous rotation hip-z joint and a continuous rotation back-z joint). In some embodiments, a robot includes at least three continuous rotation joints (e.g., a continuous rotation hip-z joint, continuous rotation back-z joint, and a continuous rotation neck-z joint). It should be appreciated that other configurations are also possible. Additionally, it should be appreciated that continuous rotation joints may not strictly be necessary to perform all aspects of the invention (e.g., all of the extra-human behaviors) described herein. Additionally, some extra-human behaviors, whether described herein or not, may be performed using a combination of continuous rotation joints and non-continuous rotation joints and/or using rotations of some joints that are not achievable by a corresponding human joint and using rotations of other joints that are achievable by a corresponding human joint. As an example, a robot may bend at the knee joints (e.g., knee joint 240) to lower the robot's center of mass prior to (or simultaneous with) performing a behavior that includes an extra-human rotation of one or more joints (e.g., rotation or one or both “hip-z” joints actuated by electric actuators 236).

As described above, the inclusion of a set of joints in a humanoid robot that permit a degree of rotation that exceeds the range of motion of corresponding human joints enables the robot to perform extra-human or “super-human” behaviors that may result in particularly efficient movements and/or object manipulations that humans may be unable to perform. Additionally, the use of such joints in a humanoid robot may simplify the design of such robots by permitting enhanced movement flexibility using fewer components. For example, rather than providing vision sensors (e.g., cameras, distance sensors, etc.) on multiple (e.g., front and back) surfaces of a head (e.g., head 210) of a humanoid robot, which may be expensive, an actuator in the neck (e.g., electric actuator 250) may be used to rotate the head so the robot can “look” behind the robot when desired. Additionally, providing an actuator in the neck (e.g., electric actuator 250) that enables continuous rotation of the head to be controlled independently of other links (e.g., the arms or legs) of the robot enables the robot to orient its vision sensors in the head at any point of interest in the robot's environment without interfering with a motion of the rest of the components of the robot. For example, a motion planner may be configured to coordinate motion of the robot's legs (and possibly also torso and arms) of the robot to perform a locomotion and/or manipulation task. The motion planner may also be configured to independently control rotation of the head to look at a current object being manipulated, a next object to be manipulated, or some other point of interest in the robot's environment, which may be located at an arbitrary heading relative to the direction of travel of the robot.

In some embodiments, a robot may include a motion planner (e.g., a model predictive controller (MPC)) configured to determine a set of parameters for the robot (e.g., a trajectory for the robot) over a specified time horizon (e.g., a period of 1 second or 1-2 seconds). Such an MPC may represent the state of the robot as the configuration (e.g., angle) and velocity of every joint in the robot. Motion planners for humanoid robots may generate a motion plan across multiple portions of the robot (e.g. head, torso, legs, arms) while considering rotational direction consistency and rotation angle limitations for each joint of the robot. The inventors have recognized and appreciated that decoupling the motion of various portions of the robot using continuous rotation joints may simplify motion planning for the robot by reducing or eliminating the need to consider such consistencies or range of motion limitations when motion planning. For example, in some embodiments, a motion planner that is continuous rotation “aware” may efficiently determine one or more trajectories for the robot based on information about a desired task to be performed (e.g., a set of foot touchdown locations, a desired manipulation of an object in the robot's environment, etc.). In some embodiments, the motion planner may take as input one or more desired trajectories associated with performing a task and the motion planner may output a set of actuator commands to coordinate and control multiple portions of the robot based on the one or more reference trajectories. For instance, a robot may be controlled to perform a task involving placing an object grasped by the robot on a shelf at a location behind a current location of the robot. To perform this task the motion planner may be provided with a first trajectory reference for the object (e.g., move the object through space in an arc), a second trajectory reference for the torso (e.g., move the torso through space in an arc approximately behind the object), and a third trajectory reference for the feet (e.g., move the feet through space in an arc approximately under the torso rotate 180 degrees). The motion planner may then determine how to perform movements of the object, torso and feet together based on the reference trajectories and information about the joint degrees of freedom including one or more continuous joints.

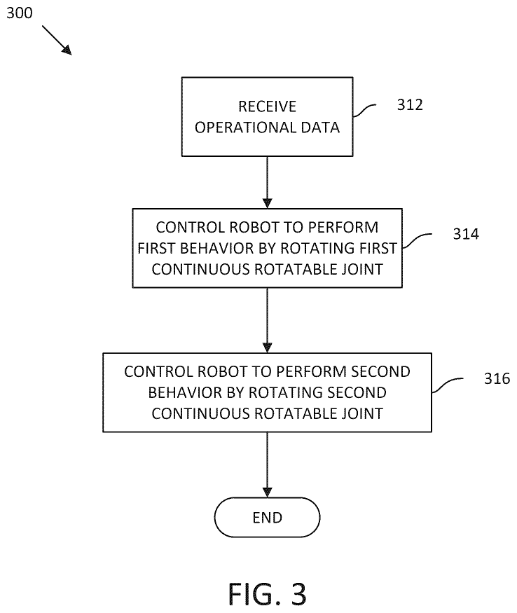

FIG. 3 is a flowchart of a process 300 for controlling a robot to perform a task using extra-human behaviors, according to some embodiments of the present invention. Process 300 begins in act 312, where task information associated with a task to be performed by the robot is received. The task may be a relatively simple task, such as walking from a first location to a second location, grasping and picking up an object, placing an object at a location, etc., or a more complex task that requires a sequence of coordinated movements and/or object manipulations, such as grasping and moving objects between locations, moving objects in confined spaces, dancing, etc. Examples of performing various tasks using extra-human behaviors in accordance with some embodiments are described in further detail below.

After receiving task information, process 300 proceeds to act 314, where the robot is controlled to perform a first behavior by rotating a first continuous rotation joint. For example, as described further below, in some embodiments, the legs of the robot may be rotated at its hip-z joints as the robot walks from a first location to a second location to enable the pelvis and legs of the robot to “face” directly towards the second location (e.g., within the first stride, which is a highly efficient way of walking). Process 300 then proceeds to act 316, where the robot is controlled to perform a second behavior by rotating a second continuous rotation joint. For example, continuing the example of the robot performing the task of walking from a first location to a second location, the robot may rotate its torso relative to its pelvis at its back-z joint such that the torso and head are facing in the direction of travel (e.g., facing toward the second location). Alternatively, the head of the robot may be rotated relative to the torso at its neck-z joint to face the direction of travel without rotating the torso. By rotating an attached member about a joint in ways that are not possible in humans, the robot may be capable of efficiently turning and walking directly to any arbitrary location (e.g., a location immediately behind its original pose). It should be appreciated that the use of joints that permit a large degree of rotation (e.g., continuous rotation joints) may permit a wide range of movements that enables a humanoid robot to perform tasks with a similar or better efficiency compared with humans. Additionally, in some embodiments, one or more components of the robot (e.g., the robot's torso) may be front-back symmetrical (or near symmetrical) such that each side of the component can be used interchangeably without having to always return the component to a nominal rotation position (e.g., 0 degrees). Stated differently, some components of a robot (e.g., the pelvis) designed in accordance with the techniques described herein may be configured to operate similarly when oriented at 0 degrees or 180 degrees about a joint axis.

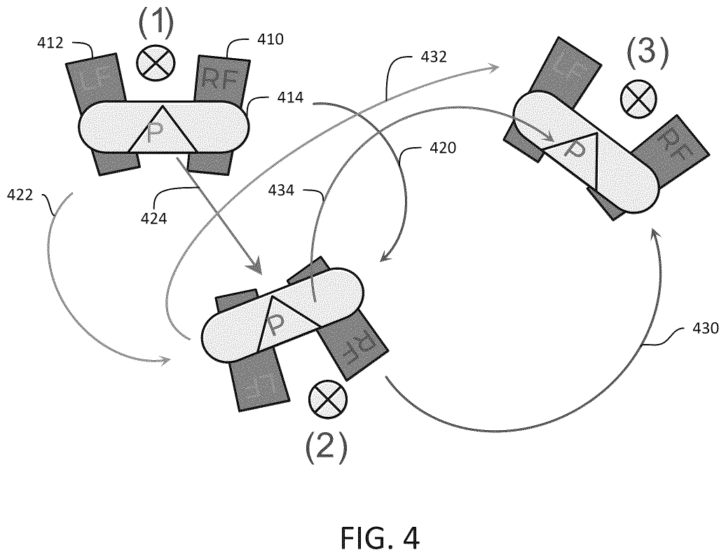

Turning and walking in an arbitrary direction from a first location to a second location typically requires conventional humanoid robots to take small steps and/or walk in a relatively long path (e.g., in an arc connecting the two locations). The inventors have recognized and appreciated that a humanoid robot including a set of continuous rotation joints may turn more efficiently than conventional humanoid robots by using extra-human behaviors. FIG. 4 illustrates an example scenario in which a humanoid robot (e.g., humanoid robot 290) efficiently moves between different locations, in accordance with some embodiments of the present invention. In the example scenario shown in FIG. 4, the humanoid robot includes a right foot 410 a left foot 412 and a pelvis 414 (e.g., pelvis base 220 in FIG. 2B). At a first location, the robot may have a first pose in which the right foot 410, left foot 412 and pelvis 414 are all facing toward a first waypoint (1). A first task may be to have the robot walk to a second location with the robot's feet facing a second waypoint (2). As shown in FIG. 4, continuous rotation at the robot's hip-z joints enables the robot to travel between the first location and the second location along a straight path 424. For instance, the right leg of the robot may be rotated at the right hip-z joint (as illustrated by arc 420) to invert the right leg and the left leg of the robot may be rotated at the left hip-z joint (as illustrated by arc 422) to invert the left leg. As shown, the right leg rotates in a first (e.g., clockwise) direction and the left leg rotates in a second (e.g., counterclockwise) direction. It should be appreciated that when implemented as continuous rotation joints, rotation about the hip-z joints may proceed in either direction (e.g., clockwise or counterclockwise). In some embodiments, the direction of rotation for a particular leg may be selected by minimizing an amount of rotation to the target orientation. In some embodiments, the direction of rotation may be selected to have the feet facing away from the center of the robot during the rotation to reduce a risk of collision of the feet with other parts of the robot. In some embodiments, the direction of rotation may be selected to have the feet facing toward the center of the robot during the rotation to reduce a risk of collision of the feet with an object in the robot's environment (e.g., when the robot is operating in a confined space or close to a wall). In some embodiments, a control system of the robot may determine a motion plan that includes information about how the robot should move to accomplish a particular task, and the motion plan may be informed by the inclusion of a set of continuous joints in the robot. In some embodiments, the motion plan may be determined by optimizing an objective or set of objectives to achieve a goal-directed behavior (e.g., by accomplishing a particular task). For instance, the objective or set of objectives may be optimized by a control system of the robot in some embodiments by minimizing a distance of travel for the robot to move between a first location and a second location, minimizing energy exerted in performing the task, achieving a certain type of motion while performing the task, or by taking into account any other suitable factors.

With the legs (and their corresponding feet) now facing in the direction of travel toward the second location, the robot may proceed to walk along the straight path 424 arriving at the second waypoint (2) with a desired pose. In some embodiments, the motion plan determined by a control system of the robot may include a step plan for the robot, with the step plan indicating a target location of one or more steps to achieve all or a portion of a given task. In some embodiments, the inversion of the right leg and the left leg by rotation about their corresponding hip-z axes may be performed as the robot is taking a step according to the step plan. For example, the right leg may be inverted when taking a first step and the left leg may be inverted when taking a second step. In another example, either the right leg or the left leg may act as a pivot point, and the pelvis of the robot may rotate relative to the pivot leg at the corresponding hip-z joint while the leg (i.e., the non-pivot leg) is lifted from the ground. In the example shown in FIG. 4, the orientation of the pelvis is pointed toward the waypoint (1) in the first pose at the first location and away from waypoint (2) in the second pose at the second location. Although the pelvis has not rotated (or has rotated slightly), the torso or the head of the robot (not shown in FIG. 4) may be rotated about a corresponding joint to face in the direction of travel to facilitate navigation of the robot from the first location to the second location. As should be appreciated, in the transition from the first pose to the second pose, the right foot in the first pose becomes the left foot in the second pose and the left foot in the first pose becomes the right foot in the second pose.

A second task may be to have the robot in the second pose walk from the second location to a third location with the robot's feet facing a third waypoint (3) in a third pose. As shown in FIG. 4, continuous rotation at the robot's hip-z joints enables the robot to travel between the second location and the third location in an efficient manner. For instance, the right leg of the robot may be rotated at the right hip-z joint (as illustrated by arc 430) to invert the right leg and the left leg of the robot may be rotated at the left hip-z joint (as illustrated by arc 432) to invert the left leg. The pelvis may also be rotated at the back-z joint (as illustrated by arc 434). With the legs (and their corresponding feet) now facing in the direction of travel toward the third location, the robot may proceed to walk along the shortest path arriving at the second waypoint (3) with a desired pose. As should be appreciated, in the transition from the second pose to the third pose, the right foot in the second pose becomes the left foot in the third pose and the left foot in the second pose becomes the right foot in the third pose. In some embodiments, the use of a set of continuous rotation joints enables the robot to travel between any two arbitrary locations in an environment without having to rotate the torso more than 90 degrees.

In some embodiments, the torso of the robot may be symmetric or near symmetric, which may enable the robot to freely invert the legs, head, arms, etc. and move in arbitrary directions about its environment and/or manipulate objects without having to rotate its torso. The inventors have recognized and appreciated that since the torso may be one of the heavier components of the robot, not having to rotate the torso in some scenarios when moving may provide for improved balance while performing a task.

Although a direction and amount of rotation of the legs and pelvis to achieve the first and second tasks is shown in FIG. 4, the speed at which the rotations may be performed is not shown. In some embodiments, relatively lightweight components such as arm members or leg members may be rotated at relatively fast speeds, whereas heavier components such as the head and torso of the robot may be rotated more slowly in an effort to reduce inertial forces that may impact the balance of the robot. In some embodiments, rotation of legs performed while the robot takes steps may be performed quickly to ensure that the rotation (e.g., a 180 degree rotation) can be completed within a single step. By contrast, rotations of other components (e.g., torso, head, arms, etc.) that may not need to be performed within a single step may be performed more slowly if desired. In some embodiments, a motion plan determined by a control system of the robot may specify the rotation speeds of various members about their corresponding joints to enable the robot to complete a task efficiently and successfully.

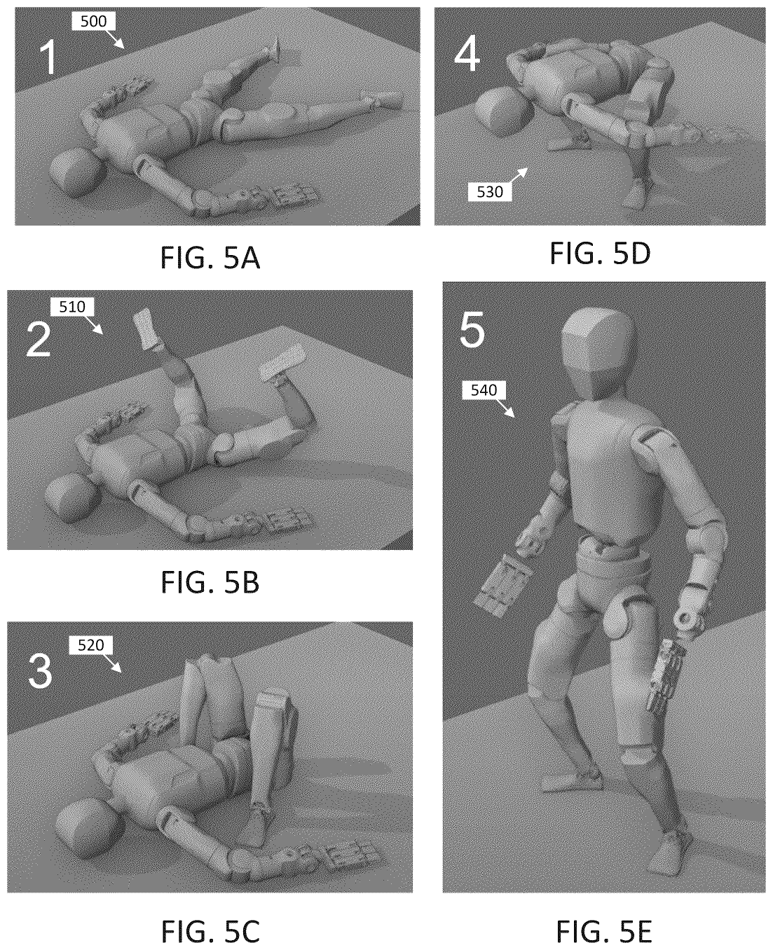

The inventors have recognized and appreciated that a robot designed in accordance with the techniques described herein may be capable of performing a wide variety of extra-human behaviors, examples of which are described in connection with FIGS. 5-15. The behaviors depicted in each of these figures are described in further detail below, though it should be appreciated that the illustrated and described behaviors are merely exemplary, and other behaviors or combinations of behaviors may also be performed.

FIGS. 5A-E illustrate a series of poses that a robot may use to transition between a laying down pose and a standing pose, in accordance with some embodiments. Typical standup behavior from a laying down position for a human or conventional humanoid robots (if self-righting is possible) involves a relatively large footprint of surface and/or coordination of multiple dynamic processes to perform the behavior. By contrast, a robot designed in accordance with some embodiments may be configured to perform a standup/laying down behavior without a dynamic phase and a relatively small footprint (e.g., a footprint no larger than the robot itself).

As shown in FIG. 5A, the robot may have an initial laying down pose 500. In pose 500 the robot may lie flat on the ground (in either a prone or a supine position) with its arms splayed to point its elbows forward and end effectors back to leave space beneath the upper arm members. As shown in FIG. 5B, to begin the standup behavior, the robot may curl its legs and point its knees downward as shown in pose 510. Pose 510 may be achieved by rotating each of robot's legs relative to the pelvis at a corresponding hip joint (e.g., a corresponding hip-y joint) and rotating the lower leg member of each leg relative to the upper leg member at a corresponding knee joint. As shown in FIG. 5A, the initial pose 500 has the legs oriented with the feet pointed to the sides. Accordingly, the transition from pose 500 to pose 510 may also be achieved by rotating the legs at their corresponding hip-z joints to point the knees toward the ground surface. As shown in FIG. 5C, the standup behavior may proceed by continuing to curl the legs until a pose 520 is achieved in which the two feet are placed on the ground surface adjacent to the respective sides of the torso in the spaces created by splaying the arms in the initial pose 500. In some embodiments, the locations of placing the feet when transitioning between poses 510 and 520 may be determined, at least in part, on a center of mass of the robot. For example, the center of mass of the robot in the configuration prior to standing up, may constrain the placement of the feet on the surface so that the center of mass projection onto the surface falls within the support polygon. It should be appreciated that different robots with different centers of mass (e.g., robots without heads, robots with different distribution of weight in its torso, etc.) may require different foot placement and that some configurations may not be able to stand up using only its legs. As shown in FIG. 5D, the standing behavior may proceed by rotating the legs relative to the pelvis (e.g., at the corresponding hip-y joints) while the feet remain in contact with the ground surface to achieve a pose 530 in which the robot's torso is lifted from the surface. As shown in FIG. 5E, the standing behavior may proceed by continuing to rotate the legs relative to the pelvis (e.g., at the corresponding hip-y joints) and rotating the upper leg members relative to the lower leg members about the corresponding knee joints to extend the legs upwards until a pose 540 in which the robot is in a standing pose is achieved. Although FIGS. 5A-5E illustrate a series of poses to perform a standup behavior without any dynamic phases, it should be appreciated that the poses may alternatively be performed in the opposite direction (e.g., from pose 540 in FIG. 5E to pose 500 in FIG. 5A) to perform a laying down behavior from an initial standing pose.

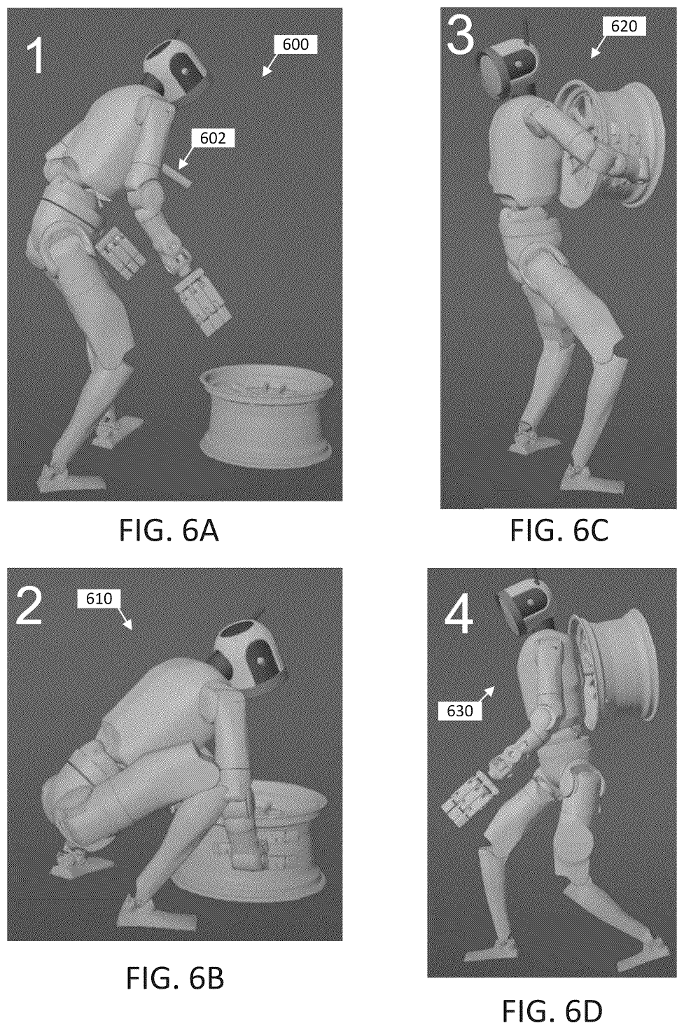

Robots are often tasked with pick-and-place operations where the robot must grasp the object at a first location, transport the object to a second location, and place the object at the second location. Although the object can be transported from the first location to the second location while grasped in one or more end effectors of the robot, it may be advantageous to couple the object to the torso of the robot to keep the one or more end effectors free when walking, to improve balance and/or coordination during walking, to transport heavier and/or irregularly shaped objects, etc. It may also be advantageous in some scenarios not to have the object coupled in front of the robot's torso while walking from the first location to the second location. FIGS. 6A-6D illustrate a series of poses that a robot may use to grasp an object and couple the object to the robot's back (e.g., carrying the object in a “backpack” position) prior to transporting the object to a different location, in accordance with some embodiments.

As shown in FIG. 6A, the robot may have an initial pose 600 in which the robot may approach an object at a first location. The robot may include one or more fasteners 602 on the side of the robot's torso facing the object when grasped. In some embodiments, the torso may have different fasteners on different sides (e.g., front or back) of the robot. Due to the inclusion of back-z and neck-z continuous rotation joints, the side of the torso having the desired fastener to couple an object for a particular task may be oriented to face the object prior to grasping it. In some embodiments, the fastener(s) include a tooling such as a rod, one or more brackets, one or more hooks, or any other suitable fastener. In some embodiments, the torso of the robot may include a configurable interface that enables different fasteners to be attached to (and/or removed from) the torso for securing and carrying different types of objects.

As shown in FIG. 6B, the robot may proceed to grasp the object by rotating various joints in its hips and knees to crouch down into a pose 610 where it is able to reach the object with its end effectors. In the example scenario shown in FIG. 6B, the object is located on a low surface (e.g., a ground surface) and the robot crouches down to be able to reach and secure a grasp on the object. In other scenarios, the object to be carried may be at a location (e.g., on a shelf) that does not require the robot to bend down to grasp the object. In yet further scenarios, the object to be carried may be located above the robot's torso (e.g., on a high shelf) and the robot may be controlled to reach up to grasp the object.

As shown in FIG. 6C, after grasping the object, the grasped object may be coupled to the robot as shown in pose 620. For example, the robot may couple the object to a fastener (e.g., fastener 602 shown in FIG. 6A) arranged on the robot's torso. As shown in FIG. 6D, after the object is coupled to the robot (e.g., on the fastener 602), the pose of the robot may be inverted to achieve pose 630 that enables the robot to carry the object on its back to a second location. In some embodiments, inverting the pose of the robot may be accomplished by inverting an orientation of the legs and the head of the robot relative to the pelvis and torso, respectively. The arms may also be inverted as shown in pose 630. By inverting the legs and head of the robot, but not the torso, the risk of the object decoupling from the fastener may be reduced relative to the scenario in which the torso is rotated to place the object on the robot's back. Additionally, such a behavior may be advantageous if the second location to which the object is to be transported is located behind the robot when grasping the object. In some embodiments, the torso having the object coupled thereto may be rotated to position the object on the robot's back, while not rotating the legs. Such a behavior may be advantageous if the second location to which the object is to be transported is located in front of the robot when the object is grasped.

In some embodiments, one or more components of the robot may be inverted prior to, or contemporaneous with, coupling the object to the fastener(s) on the torso of the robot. In the example shown in FIG. 6C, the head of the robot is inverted after coupling the object, while the legs remain in their original pose (e.g., facing the location where the object was grasped). Then, as shown in FIG. 6D, the arms and legs are inverted as the robot begins to walk toward the second location (e.g., while taking steps in the direction of the second location) leaving the arms free to do new manipulation tasks, e.g., making space where the carried object is to be placed.

In some embodiments, a robot may not include a fastener to which a grasped object may be coupled (or it may not be practical or advisable to use a fastener for a particular object even if the robot includes one). In such instances, the object may be carried from the first location to the second location while remaining continuously grasped by one or more end effectors of the robot. Because one or more of the end effectors are being used to grasp the object, it may not be advisable to invert the arms to change movement directions and place the object at a target location that is behind the robot. For example, if a bimanual grasp is used and the object is large and/or irregularly shaped, it may not be possible to invert the arms while carrying the object. In such a scenario, a robot configured to have extra-human behaviors may efficiently turn to walk toward the target location.

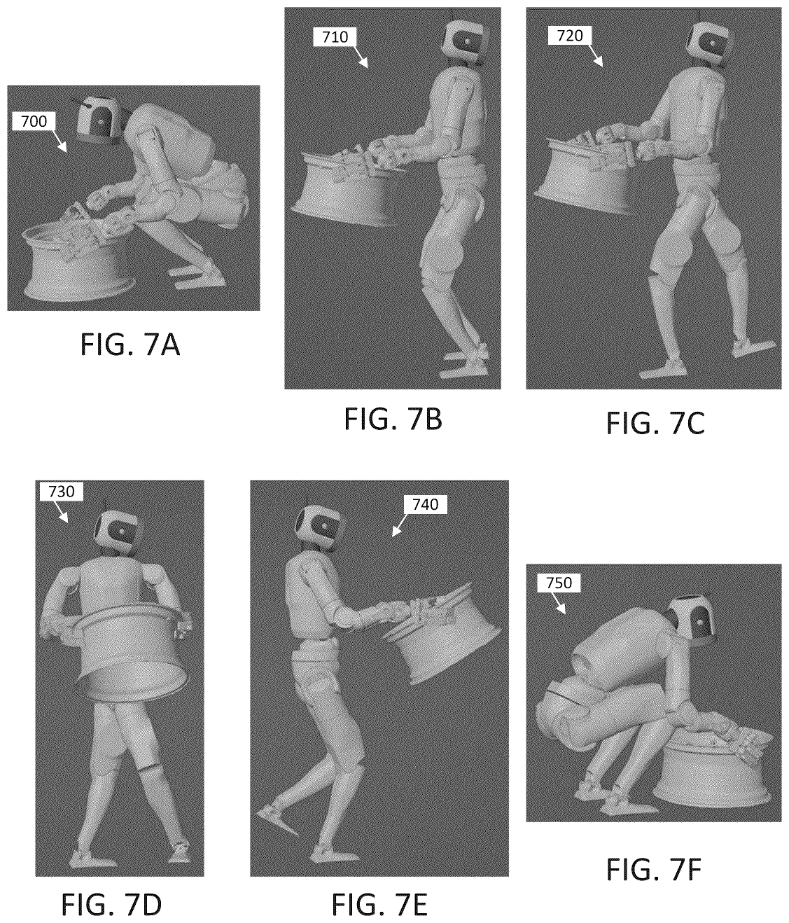

FIGS. 7A-7F illustrate a series of poses for performing a pick and place task using extra-human behaviors, in accordance with some embodiments of the invention. As shown in FIG. 7A, the robot may have an initial pose 700 to grasp an object at a first location. In the example shown in FIG. 7A, pose 700 is a crouch pose that enables the robot to grasp an object placed on a low surface. However, any other suitable pose 700 may be used to grasp an object, examples of which are described in connection with pose 610 shown in FIG. 6B. As shown in FIG. 7B, the robot may lift the object by extending its legs (if grasping the object from the low surface) and may rotate its head as shown in pose 710 to look in the desired direction of travel (e.g., toward a second location where the object is to be placed). As shown in FIG. 7C, the robot may then begin walking in the desired direction of travel by inverting one of its legs (e.g., by rotating the leg about its respective hip-z joint while taking a step in the desired direction of travel) such that its two legs are facing opposite directions in pose 720. As shown in FIG. 7D, the robot may continue to travel in the desired direction of travel by inverting its other leg (e.g., by rotating the leg about its respective hip-z joint while taking another step in the desired direction of travel) as shown in pose 730. As the robot inverts its other leg, the torso of the robot may also invert (e.g., by rotating the torso relative to the pelvis at the back-z joint and relative to the head at the neck-z joint) such that the object is carried in front of the robot. It should be appreciated that it may be advantageous and/or desirable to have the robot carry the object on the same side as the direction of travel, though doing so may not strictly be required. For instance, it may not be necessary to invert the torso as shown in pose 730 of FIG. 7D. Rather, the robot may rotate its legs and its head while walking toward its destination, while keeping its arms and the grasped object opposite the direction of travel as the robot walks to the destination to carry the object behind its back.

As shown in FIG. 7E, after the torso, legs and head have all been inverted, the robot may have a pose 740 and the robot may proceed with walking a shortest distance to the second location. As shown in FIG. 7F, after arriving at the second location, the robot may place the object in a desired manner using a pose 750. In the example shown in FIG. 7F, the object is placed at a low position in which a crouching pose 750 is used. It should be appreciated that by decoupling rotation of the lower body of the robot from the rotation of the upper body of the robot, the legs can be quickly rotated to enable the robot to begin walking toward the second location as soon as possible, while the torso may be rotated more slowly during travel to reduce rotational inertia caused by rotating a heavy structure (e.g., the torso and the object being carried), which may improve balance and stability of the object being carried in the end effector(s).

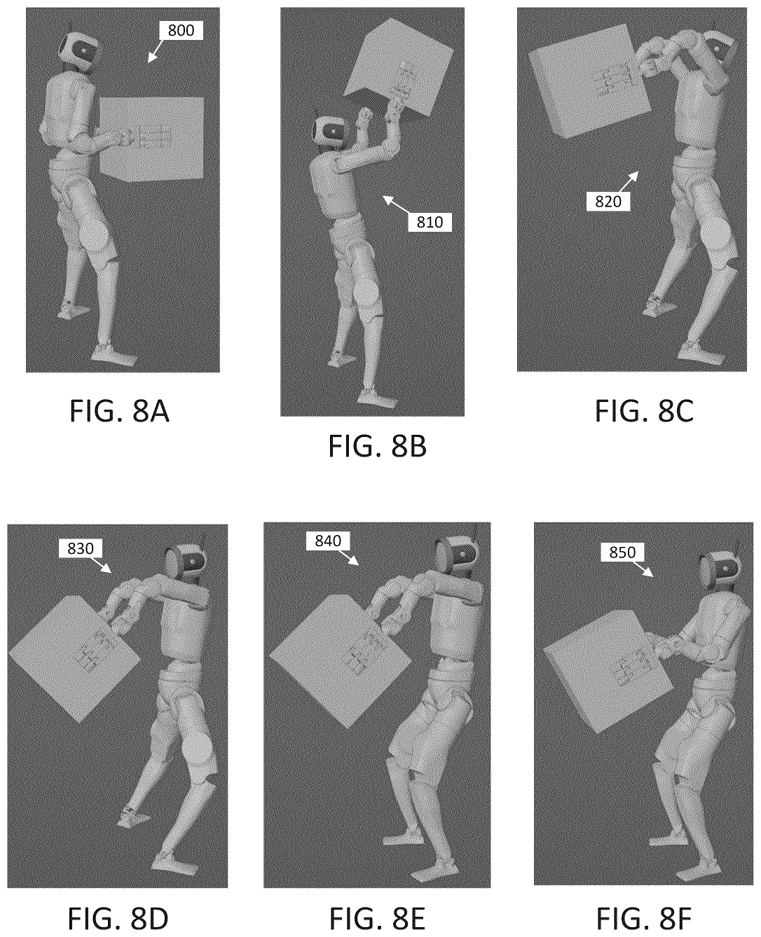

In some scenarios, it may be beneficial for a robot to invert its pose while grasping an object but without rotating its torso. For instance, if the robot is performing pick and place operations between opposing shelves in a narrow aisle of a warehouse, there may not be sufficient space in the aisle to rotate the torso of the robot while grasping an object, such as a box. Additionally, even if there is space to rotate the torso while grasping an object, such rotation may not be advisable or desired (e.g., if the object is heavy). FIGS. 8A-8F illustrate a series of poses for inverting a pose of a robot while grasping an object using extra-human behaviors, in accordance with some embodiments of the invention. As shown in FIG. 8A, the robot may have an initial pose 800 in which an object (e.g., a box) is grasped by one or more end effectors of the robot. Although a bimanual grasp of an object is shown in pose 800 of FIG. 8A, it should be appreciated that the extra-human behaviors shown in FIGS. 8A-8F may also be performed using a single arm of the robot when the object is grasped using a single end effector. As shown in pose 810 of FIG. 8B, the robot may lift the object over the robot's torso and head by rotating its arms (e.g., about its shoulder-y joints). As shown in pose 820 of FIG. 8C, the robot may continue to rotate its arms (e.g., about its shoulder-y joints) past vertical to the other side of its body (e.g., a behavior that cannot be performed by humans). As shown in pose 830 of FIG. 8D, the robot may rotate its head (e.g., about its neck-z joint) to face the direction where the object now resides. As shown in pose 840 of FIG. 8E, the robot may rotate its legs (e.g., about its hip-z joints) such that the feet of the robot are facing the direction that the object now resides. It should be appreciated that if the robot does not need to travel in the direction that the object resides (e.g., to place the object at a location within the reach of the robot), it may not be necessary to rotate the legs to face that direction, which may result in a more efficient movement. As shown in pose 850 of FIG. 8F, the elbows of the robot may be inverted (e.g., by rotating the lower arm member relative to the upper arm member at the elbow joints), such that the object is carried in a normal carry position (e.g., similar to the carry position shown in pose 800 of FIG. 8A), but now with the object being located on the opposite side of the body from which it was grasped. It should be appreciated that the extent to which the elbows are inverted between poses 840 and 850 may depend on the particular task that the robot is performing. For example, in a pick and place operation, the extent that the elbows are inverted may depend, at least in part, on a height of the location where the object is to be placed. Additionally, depending on the size of the object being grasped, it may be beneficial to extend the lower arms relative to the upper arms at the elbow joints while lifting the object over the robot's head (e.g., between poses 810 and 820) to provide more clearance between the robot's head and the object as the object is lifted over the robot's head.

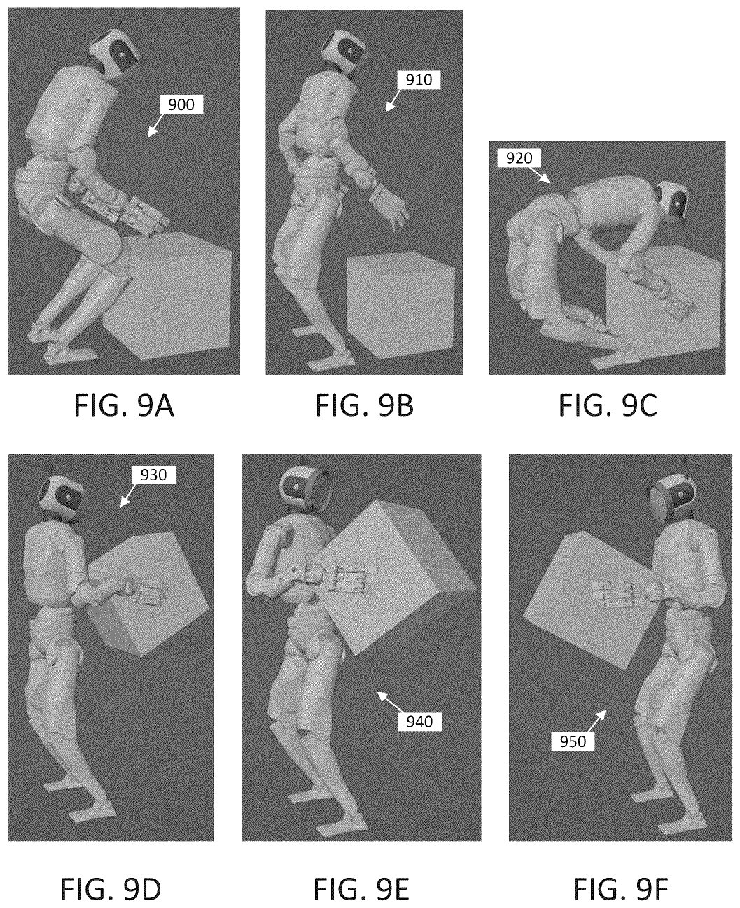

As shown in FIGS. 6B, 7A and 7F, when a robot attempts to pick and/or place an object on a low surface (e.g., a ground surface, a low shelf, etc.) the robot may assume a crouched pose in which the legs of the robot bend at the knees. In some situations, depending on the size and/or shape of the object to be grasped or placed, the knees of the robot when in the crouched position may hinder the grasp or placement of the object. In some embodiments, a robot may perform an extra-human behavior to grasp and/or place an object on a surface without obstruction by the knees. FIG. 9A illustrates a pose 900 in which a robot facing an object to be grasped is unable to crouch low enough to grasp the object due to the knees of the robot contacting the object in the crouch pose. FIGS. 9B-9F illustrate a series of poses for lifting and/or placing an object using extra-human behaviors, in accordance with some embodiments of the invention. As shown in FIG. 9B, prior to grasping an object, the robot may assume a pose 910 in which the legs of the robot are inverted (e.g., at the hip-z joints) such that the knees face away from the object to be grasped. Because the knees of the robot are facing away from the object to be grasped, there is room to grasp the object when the robot bends its knees into a crouch pose. As shown in pose 920 of FIG. 9C, the robot may rotate its legs relative to its pelvis (e.g., at the hip-y joints) to reach down and grasp the object. After grasping the object, the robot may resume a standing pose 930 as shown in FIG. 9D by rotating its legs (e.g., at the hip-y joints) relative to its pelvis. As shown in pose 940 of FIG. 9E, the robot may then rotate its torso relative to its pelvis (e.g., at the back-z joint) to rotate the upper body (including torso, head, and arms) of the robot relative to the lower body of the robot. As shown in pose 950 of FIG. 9F, after completing the rotation of the upper body relative to the lower body, the grasped object may be positioned in a direction of travel that is opposite the side of the robot's body from where the object was grasped. It should be appreciated that rather than rotating the torso, the object may instead be lifted over the robot's torso and head in the manner described in FIGS. 8A-8F, if necessary or desired.

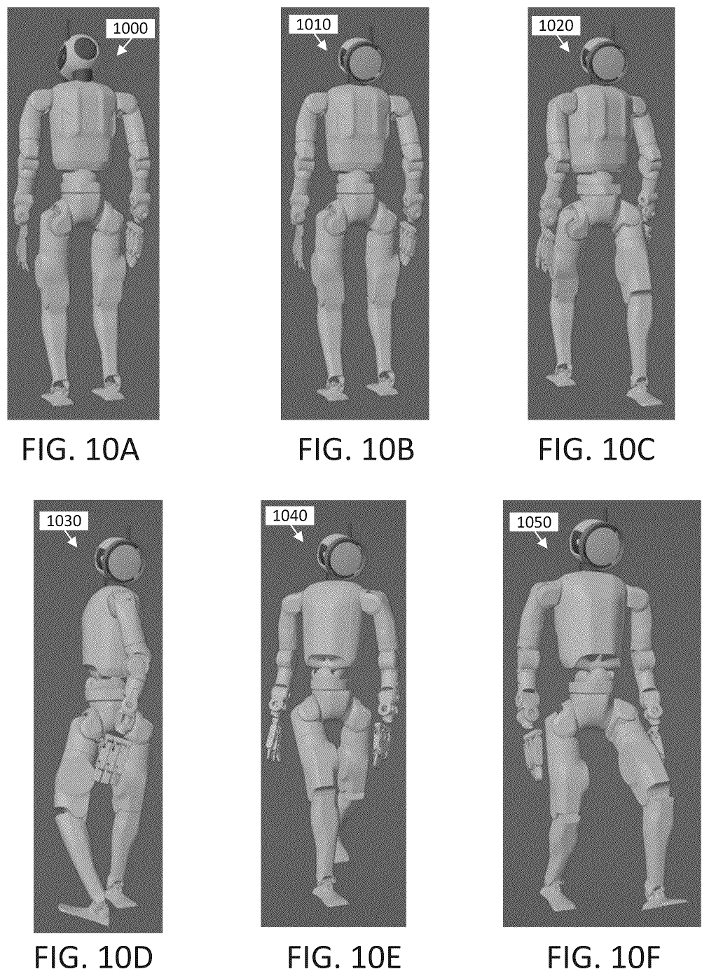

The inventors have recognized and appreciated that providing independent rotation of the head relative to the torso (e.g., at the neck-z joint) enables a robot to “look” in any arbitrary direction prior to initiating a movement in that direction. An example of such a scenario in which such an extra-human behavior may be useful is looking behind the robot prior to walking in that direction. FIGS. 10A-10F illustrate a “look back-walk back” behavior using extra-human behaviors, in accordance with some embodiments of the invention. As shown in FIG. 10A, the robot may have an initial pose 1000 in which the robot is facing a first direction. The robot may then rotate its head relative to its torso (e.g., about the neck-z joint) into a pose 1010 as shown in FIG. 10B to enable the robot to look behind the robot in a direction it wants to travel. By rotating its head prior to traveling in that direction, the robot may be able to determine whether it is safe to travel in that direction (e.g., by detecting one or more objects in its path that it cannot sense when the head is in pose 1000). As shown in FIG. 10C, the robot may then efficiently start walking in the desired direction of travel by rotating one of its legs relative to its pelvis (e.g., about a corresponding hip-z joint) as it is taking a step to achieve pose 1020 in which the legs of the robot are facing opposite directions. As shown in FIG. 10D, the robot may continue walking in the direction of travel by lifting and rotating its other leg relative to its pelvis (e.g., about a corresponding hip-z joint) to achieve pose 1030. As shown in FIG. 10D, the robot may also begin rotating its torso relative to its pelvis and head (e.g., about respective back-z and neck-z joints) to enable the arms of the robot to rotate into their natural configuration along with the torso. As shown in pose 1040 of FIG. 10E, the leg rotations may be completed prior to completion of the torso rotation, which may happen at a slower speed (e.g., to improve balance) than the rotation of the legs. As shown in pose 1050, after the legs, head, and torso have all been rotated, the robot may proceed along the desired direction of travel to its destination.

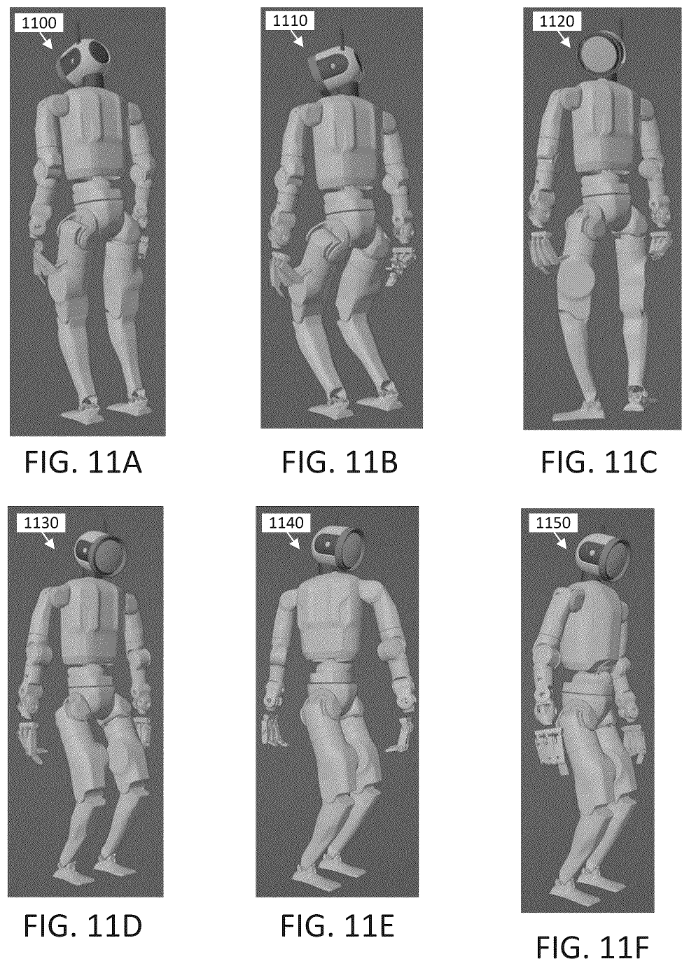

The inventors have recognized and appreciated that some of the poses that a robot exhibits when performing extra-human behaviors may be perceived as unnatural to a human observer, particularly when the robot is positioned in such unnatural poses for a length of time. In some embodiments, it may be desirable to mitigate the perception of unnatural behavior by a human observer. In some embodiments, the robot may attempt to mask the perception of one or more extra-human behaviors by performing other behaviors concurrently. As one example, the robot may be controlled to invert its pose/posture while performing a jump. FIGS. 11A-11F illustrate a series of poses for performing extra-human behaviors while executing a jump, in accordance with some embodiments of the present invention. As shown in FIG. 11A, the robot may have an initial pose 1100 in which the robot is in a standing position. The robot may then transition to pose 1110 of FIG. 11B in which the knees of the robot are flexed as an initial portion of a jumping motion. FIG. 11C shows that as the robot is mid-jump (e.g., in the air), the robot achieves a pose 1120 in which the head is rotated relative to the torso (e.g., about the neck-z joint) and the legs are also inverted (e.g., about their respective hip-z joints). As shown in FIG. 11D, when the robot completes the jumping motion, the robot is in pose 1130 in which the head and legs are now facing the opposite direction from pose 1100. As shown in FIG. 11E, the robot may achieve a pose 1140 in which the torso (and the coupled arms) is rotated relative to the head and the pelvis (e.g., at respective neck-z and back-z joints). After rotation of the torso, the robot may achieve pose 1150 shown in FIG. 11F in which the robot is facing the opposite direction as pose 1100 with all components inverted. In some embodiments, the robot may be able to perform the jump and invert behavior shown in FIGS. 11A-11F in a short period of time (e.g., less than 1 second) resulting in performance of extra-human behaviors that may be perceived as more natural.

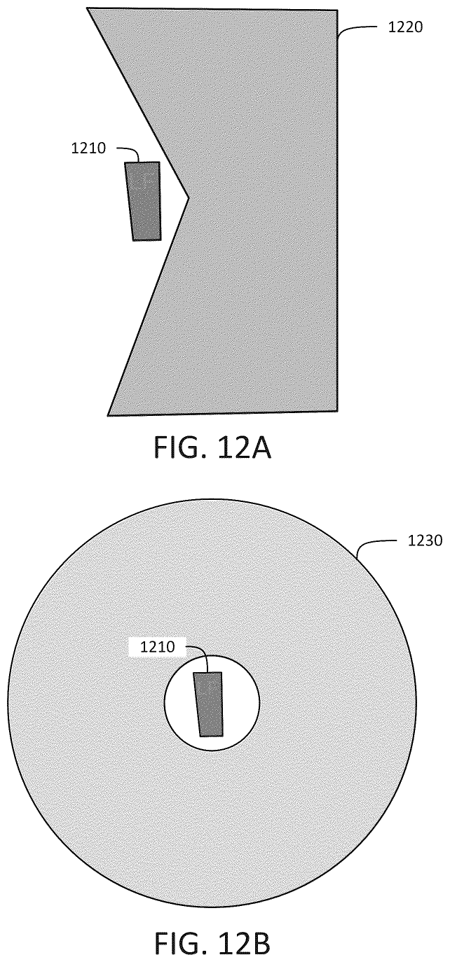

In the example extra-human behaviors described above, some of the tasks being performed by the robot may generally relate to efficiently turning to walk in arbitrary directions and manipulating grasped objects in ways that are generally not possible for humans, but are enabled by the inclusion of joints (e.g., continuous rotation joints or more generally joints with a large range of motion) that have ranges of motion greater than the ranges of motion of corresponding human joints (to the extent that analogous joints exist in humans). The inventors have also recognized and appreciated, that inclusion of such joints in a robot may permit the robot to execute step plans that are not typically achievable by conventional humanoid robots. FIG. 12A schematically illustrates an example of possible step locations for a foot of a conventional bi-pedal robot that does not include joints that permit the performance of extra-human behaviors. As shown in FIG. 12A, when the left foot 1210 of the robot is located on a surface, a possible stepping region 1220 for the right foot may be defined based on the kinematic constraints of the robot. As can be observed, possible stepping region 1220 includes areas to the right of the robot and slightly in front of the robot, but it is not possible for the right foot to cross over the left foot and land outside the region 1220.

FIG. 12B schematically illustrates an example of possible step location for a foot of a robot that includes joints that permit the performance of extra-human behaviors, in accordance with some embodiments of the present invention. As shown in FIG. 12B, when a set of continuous rotation joints (e.g., including hip-z and back-z joints) are used, the possible stepping region 1220 for the right foot shown in FIG. 12A is expanded to the possible stepping region 1230 as shown in FIG. 12B. As should be appreciated, a robot including a set of continuous rotation joints may be capable of omnidirectional stepping (i.e., stepping in any direction), which may enable the robot to perform stepping behaviors that are challenging or impossible for conventional humanoid robots to perform successfully. Additionally, the ability to perform omnidirectional stepping may facilitate step recovery. For instance, if the robot starts to lose its balance, a leg may be rotated and a foot placed in any arbitrary direction which may assist with recovery of balance of the robot. Additionally, the ability to perform omnidirectional stepping may enable more efficient (e.g., more time and/or energy efficient) planning and/or execution of motion of the robot as compared with conventional humanoid robot.

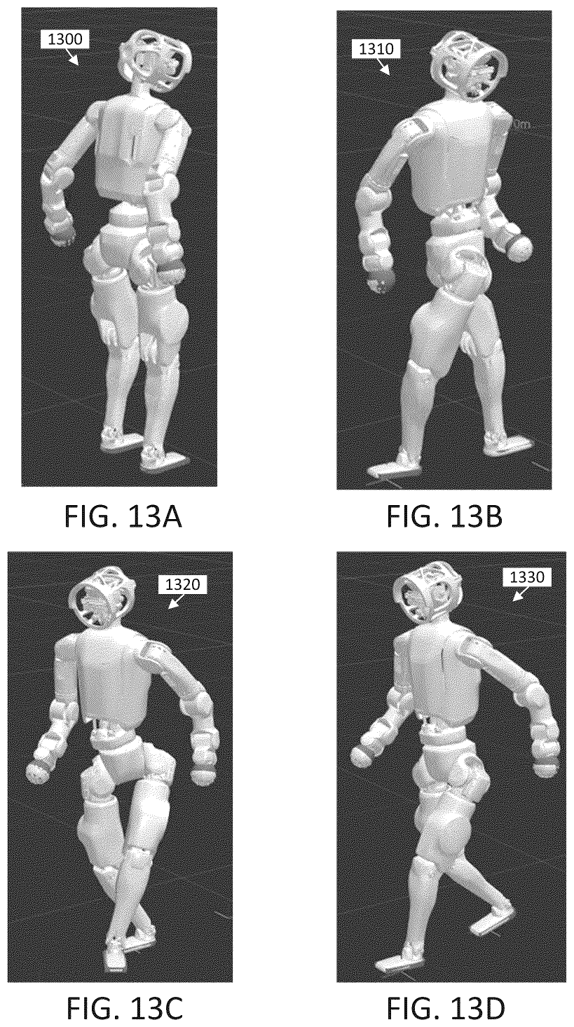

FIGS. 13A-13D illustrate a series of poses for a robot performing omnidirectional stepping, in accordance with some embodiments of the present invention. As shown in FIG. 13A, the robot may have an initial pose 1300 in which the robot is standing facing a first direction. The robot may then perform a step to achieve a second pose 1310 as shown in FIG. 13B in which the robot has rotated its right leg 180 degrees relative to pose 1300 (e.g., by rotating the right leg about its hip-z joint), while also rotating its torso and head relative to its pelvis (e.g., by rotating the torso relative to the pelvis about the back-z joint). Such a step would fall outside of the possible stepping region 1220 for a conventional humanoid robot. The robot may continue to execute a step plan by performing another step to achieve a pose 1320 as shown in FIG. 13C. To achieve pose 1320, the robot may pivot on its right leg and rotate its left leg around to have its left foot step in front of its right foot along a desired direction of travel. As shown in FIG. 13D, the robot may rotate its torso relative to its pelvis (e.g., about its back-z joint) to achieve pose 1330 in which the legs, torso, head, and arms of the robot are all facing the desired direction of travel.

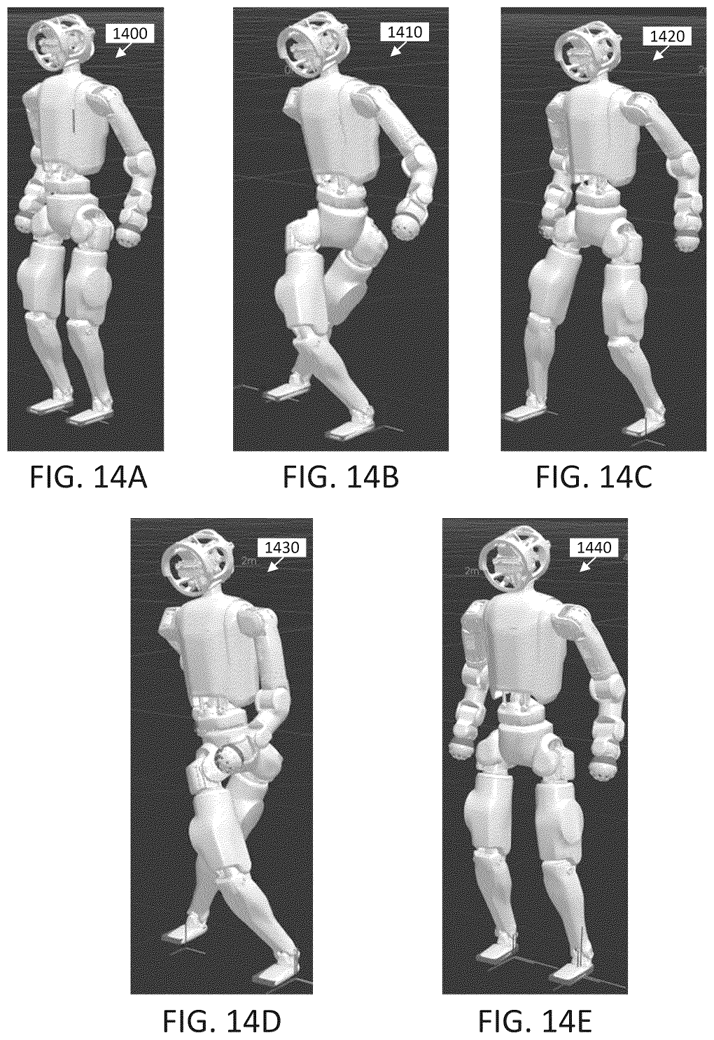

FIGS. 14A-14E illustrate a series of poses for a robot performing lateral crossover stepping (also commonly referred to as strafing), in accordance with some embodiments of the present invention. Strafing may be particularly useful if, for example, the robot performs a task that requires lateral movement along a narrow passageway that restricts the ability of the robot to move in other ways, or if the task involves climbing up a narrow set of stairs. As shown in FIG. 14A, the robot may have an initial pose 1400 in which the robot is standing facing a first direction. The robot may then perform a crossover step with its right foot to achieve a second pose 1410 as shown in FIG. 14B in which the robot has rotated its pelvis counterclockwise relative to its torso (e.g., by rotating the pelvis about the back-z joint) to extend the reach of the right foot over the left foot during the step, while keeping its torso and head facing the same direction as pose 1400. Such a lateral crossover step would fall outside of the possible stepping region 1220 for a conventional humanoid robot. The robot may continue to execute a step plan by performing another step to achieve a pose 1420 as shown in FIG. 14C. Pose 1420 may be achieved by the robot taking a step with its left leg while rotating its pelvis clockwise relative to its torso (e.g., by rotating the pelvis about the back-z joint). The robot may continue to execute the step plan by performing another lateral crossover step with the right leg to achieve a pose 1430 shown in FIG. 14D in a similar manner as the lateral crossover step shown in FIG. 14B. As should be appreciated, the joints may be rotated as needed to achieve a desired amount of lateral spacing between the feet upon completion of the lateral crossover step. As shown in FIG. 14E, the robot may continue the step plan to achieve pose 1440 in which the robot is facing the same direction as initial pose 1400 and is standing at a second location that is laterally displaced from a first location in which the step plan was started.

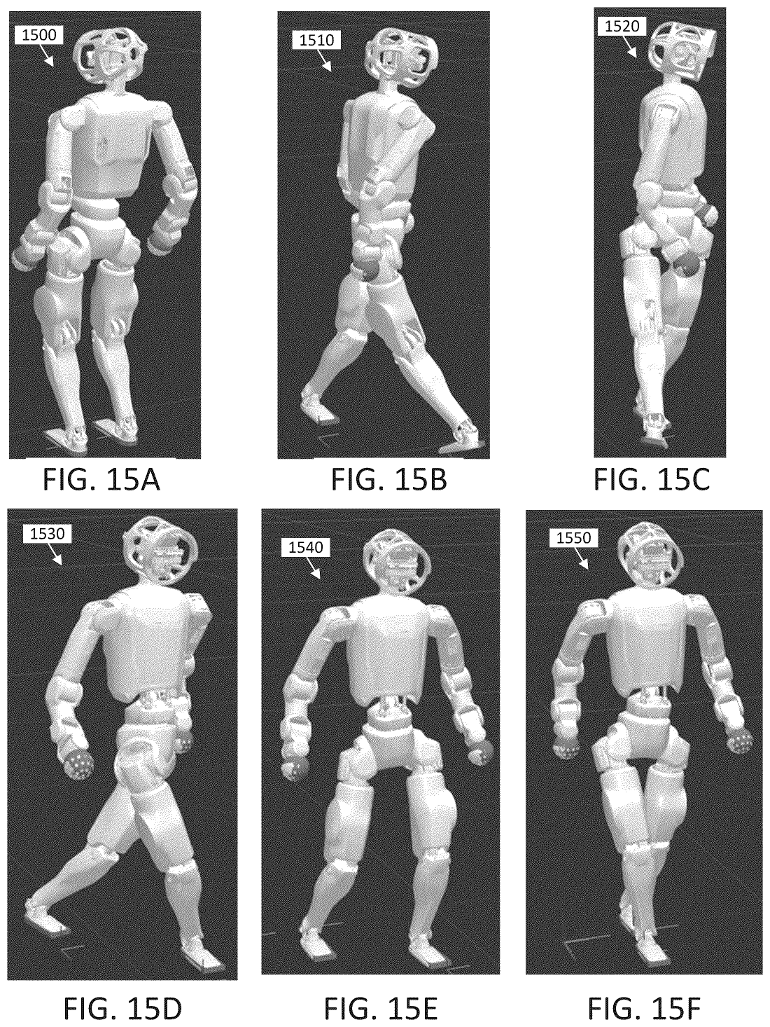

As illustrated in the example omnidirectional stepping behavior shown in FIGS. 13A-13D, a robot having a set of continuous rotation joints can efficiently invert its body by changing its direction of travel. As illustrated in the example lateral crossover stepping behavior shown in FIGS. 14A-14E, a robot having a set of continuous rotation joints can efficiently perform lateral crossover stepping to move laterally between two locations. FIGS. 15A-15F illustrate a series of poses for a robot in which the direction inversion of FIGS. 13A-13D and the lateral crossover stepping of FIGS. 14-14E are combined into a step plan in which the robot twirls while moving laterally, in accordance with some embodiments of the present invention.

As shown in FIG. 15A, the robot may have an initial pose 1500 in which the robot is standing facing a first direction. The robot may then step forward with a first foot (e.g., its right foot in this configuration) while also crossing the first foot over the second foot (e.g., its left foot in this configuration) to achieve a pose 1510 as shown in FIG. 15B in which the feet of the robot are facing each other. To achieve pose 1510, the robot may (1) rotate its first leg relative to its pelvis (e.g., at the corresponding hip-z joint) to rotate the leg 180 degrees from pose 1500 and (2) rotate its pelvis relative to its torso (e.g., at the back-z joint) to extend the reach of the first leg and enable the crossover stepping. Such a step from pose 1500 would fall outside of the possible stepping region 1220 for a conventional humanoid robot. The robot may continue to execute a step plan by performing another step to achieve a pose 1520 as shown in FIG. 15C. Pose 1520 may be achieved by the robot pivoting on its first foot and rotating its second leg with the aim to take a step with the second foot behind the location of the first foot. Continuing with the step plan, the robot may achieve pose 1530 shown in FIG. 15D by completing rotation of the second leg and the torso during the step initiated in pose 1520, resulting in the second foot being positioned behind the first foot. As should be appreciated, in pose 1530, the robot is now facing the opposite direction from the initial pose 1500, with the rotation being achieved using a combination of inversion and crossover stepping behaviors. The robot may continue to execute the step plan by taking a backward step with the first foot to achieve pose 1540 in which the first foot is located behind the second foot. As shown in FIG. 15F, the robot may continue the step plan to achieve pose 1540 by taking a further backward step with the second foot.

Including joints in a robot (e.g., a humanoid robot) that have a large (or unlimited) range of rotation about the joint and/or are positioned at places that are different from human joints (e.g., continuous rotation hip-z joints) may enable a wide range of extra-human behaviors, which may facilitate efficient movement of the robot and/or manipulation of objects by the robot. However, as discussed above, some extra-human behaviors may be perceived as unnatural by a human observer. Some embodiments of the present invention address the perception of unnaturalness of some extra-human behaviors by attempting to make certain extra-human behaviors less perceptible to a human observer. For example, performing certain extra-human behaviors quickly and/or in combination with another behavior may mask the perception of unnaturalness compared with when the extra-human behavior is performed slowly (or maintains its unnatural pose for a relatively long time) and/or when the extra-human behavior is performed in isolation. The jump-inversion behavior shown in FIGS. 11A-11F is an example of simultaneously performing another behavior (e.g., a jump) that may lessen the unnatural perception of rotating limbs and/or a head of a robot.

In some embodiments, a robot capable of performing extra-human behaviors may have different modes of operation, such as a normal operation mode and an extra-human operation mode. In normal operation mode, although a robot may be capable of performing a wide range of extra-human behaviors, the control system of the robot may constrain the robot's available behaviors to a subset of the available behaviors. As an example, the robot may be constrained to perform “human-only” behaviors representing behaviors that humans can also perform. As another example, the robot may be constrained to perform only a subset of extra-human behaviors that the robot is capable of performing (e.g., a subset of extra-human behaviors that are deemed to be less unnatural). In extra-human operation mode, the robot may be configured to perform a full set of extra-human behaviors that its joints and morphology allow. In some embodiments, switching between the different modes of operation may be performed based, at least in part, on whether human observers are present. For example, when human observers are present, the robot may be configured or “locked” to operate in normal operation mode, whereas when human observers are not present, the robot may be configured or “unlocked” to operate in extra-human operation mode. The determination of whether human observers are present may be made autonomously by the robot, manually by an operator of the robot, or in another suitable way.

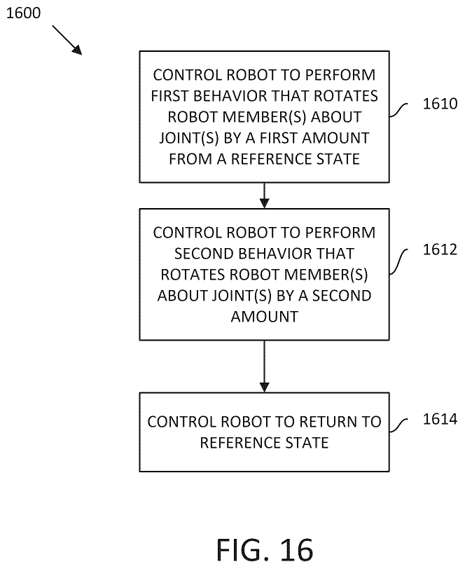

As discussed above, the inventors have recognized and appreciated that the amount of time that a robot is posed in an unnatural posture may contribute to the perception of the pose being unnatural. For instance, although it may be possible for a robot to walk forward with its torso and arms facing backward and its legs and head facing forward, such a configuration may be perceived as unnatural by a human observer. To alleviate such unnatural perception where desired, some embodiments attempt to return the robot to a reference state (e.g., a nominal standing pose) when possible. FIG. 16 is flowchart of a process 1600 for controlling a robot to return to a reference state, in accordance with some embodiments of the present invention. Process 1600 begins in act 1610, where the robot is controlled (e.g., based on a motion plan) to perform a first behavior that rotates one or more robot members about one or more robot joints by a first amount from a reference state. Process 1600 then proceeds to act 1612, where the robot is controlled to perform a second behavior that rotates the one or more members (e.g., the same members or different members rotated in act 1610) about the one or more joints (e.g., the same joints or different joints around which the member(s) are rotated in act 1610) by a second amount. In some embodiments, performing the first behavior and/or performing the second behavior may result in the posture of the robot being perceived as unnatural to a human observer. Process 1600 then proceeds to act 1614, where the robot is controlled to return to the reference state, such that the perception of the robot having an unnatural pose or posture is reduced. In this way, as the robot is performing various tasks, the robot may be biased toward adopting certain reference state poses or postures, when possible, to facilitate the perception of naturalness. Returning to the embodiments in which a robot has different modes of operation, in the normal operation mode, the control system of the robot may attempt to return the robot to a reference state, whereas in the extra-human operation mode, the control system may not attempt to return the robot to a reference state.

A number of implementations have been described. Nevertheless, it will be understood that various modifications may be made without departing from the spirit and scope of the disclosure.

1. A robot, comprising:
a base;
a set of continuous rotation joints, each continuous rotation joint permitting continuous rotation of an attached member about a corresponding axis, wherein the set of continuous rotation joints includes a first hip joint, a second hip joint, and a back joint;
a first leg member coupled to the base via the first hip joint;
a second leg member coupled to the base via the second hip joint; and
a torso coupled to the base via the back joint.

2. The robot of claim 1, wherein the set of continuous rotation joints further includes a neck joint, the robot further comprising:
a head coupled to the torso via the neck joint.

3. The robot of claim 1, wherein the set of continuous rotation joints further includes a third hip joint and a fourth hip joint, the robot further comprising:
a first intermediate member coupled to the base at the third hip joint and coupled to the first leg member at the first hip joint; and
a second intermediate member coupled to the base at the fourth hip joint and coupled to the second leg member at the second hip joint.

4. The robot of claim 1, further comprising:
a first knee joint;
a second knee joint;
a first ankle joint;
a second ankle joint;
a third leg member coupled to the first leg member at the first knee joint;
a first foot coupled to the third leg member at the first ankle joint;
a fourth leg member coupled to the second leg member at the second knee joint; and
a second foot coupled to the fourth leg member at the second ankle joint.

5. The robot of claim 4, wherein each of the first knee joint, the second knee joint, the first ankle joint, and the second ankle joint is not included in the set of continuous rotation joints.

6. The robot of claim 1, wherein the set of continuous rotation joints further includes a first shoulder joint and a second shoulder joint, the robot further comprising:
a first arm member coupled to the torso via the first shoulder joint; and
a second arm member coupled to the torso via the second shoulder joint.

7. The robot of claim 6, wherein the set of continuous rotation joints further includes a third shoulder joint and a fourth shoulder joint, the robot further comprising:
a first intermediate arm member coupled to the torso at the third shoulder joint and coupled to the first arm member at the first shoulder joint; and
a second intermediate arm member coupled to the torso at the fourth shoulder joint and coupled to the second arm member at the second shoulder joint.

8. The robot of claim 6, further comprising:
a first elbow joint;
a second elbow joint;
a third arm member coupled to the first arm member at the first elbow joint;
a first end effector coupled to the third arm member at a first wrist component;
a fourth arm member coupled to the second arm member at the second elbow joint; and
a second end effector coupled to the fourth arm member at a second wrist component.

9. The robot of claim 8, wherein each of the first elbow joint and the second elbow joint is not included in the set of continuous rotation joints.

10. The robot of claim 8, wherein
the first end effector is a first gripper configured to grasp a first portion of a first object, and
the second end effector is a second gripper configured to grasp a second portion of the first object or a second object.

11. The robot of claim 1, further comprising:
a set of actuators associated with the set of continuous rotation joints; and
a control system including one or more computer processors, the one or more computer processors configured to:
determine a motion plan for the robot to perform a task; and
control the set of actuators in accordance with the motion plan to perform the task.

12. The robot of claim 11, wherein determining a motion plan comprises determining a motion plan that includes rotating coupled members about respective multiple joints in the set of continuous rotation joints.

13. The robot of claim 1, wherein the base forms a pelvis structure of the robot.

14. The robot of claim 1, wherein the robot is a humanoid robot.

15. The robot of claim 1, wherein a front side and a back side of the torso are symmetric.

16. The robot of claim 1, further comprising:
a fastener coupled to the torso, wherein the fastener is configured to be coupled to an object.

17. The robot of claim 16, wherein the fastener is selected from the group consisting of a rod, a bracket, and a hook.

18-25. (canceled)

26. A method of controlling a robot having a set of continuous rotation joints including a first hip joint coupled to a first leg of the robot, a second hip joint coupled to a second leg of the robot and a back joint coupled to a torso of the robot, the method comprising:
receiving task information to perform a task, the task information specifying the robot to have a first pose at a first location and a second pose at a second location, the second pose being different from the first pose;
determining a motion plan for the robot to perform the task, wherein the motion plan includes:
rotating the first leg of the robot in a first direction about the first hip joint by a first amount that orients a front of the first leg toward the second location;
rotating the second leg of the robot in second direction about the second hip joint by a second amount that orients a front of the second leg toward the second location; and
rotating the torso about the back joint by a third amount that at least partially moves the robot toward achieving the second pose; and
controlling the robot to move based on the motion plan to perform the task.

27-68. (canceled)

69. A robot, comprising:
a torso;
a pelvis coupled to the torso at a first continuous rotation joint;
a first leg coupled to the pelvis at a second continuous rotation joint;
a second leg coupled to the pelvis at a third continuous rotation joint; and
a control system configured to control rotation of the first continuous rotation joint, the second continuous rotation joint and the third continuous rotation joint based, at least in part, on a motion plan for the robot.

70. The robot of claim 69, wherein the first continuous rotation joint, the second continuous rotation joint and the third continuous rotation joint enable the robot to perform omnidirectional stepping.

71-79. (canceled)
